(19) United States
(12) Patent Application Publication
(10) Pub. No.: US 2025/0058806 A1
(43) Pub. Date: Feb. 20, 2025

(54) TOPOLOGIES TO REDUCE FORCE RIPPLE FOR PROPULSION MOTORS AND A VEHICLE WITH OFFSET PROPULSION MOTORS TO REDUCE RIPPLE FORCE

(71) Applicant: HYPERLOOP TECHNOLOGIES, INC., Dubai (AE)

(72) Inventors: Ju Hyung KIM, Los Angeles, CA (US); Yingjie LI, Palo Alto, CA (US); Alexander JEDINGER, Long Beach, CA (US); Rachel OZER, Los Angeles, CA (US)

(21) Appl. No.: 18/723,830

(22) PCT Filed: Dec. 22, 2022
(86) PCT No.: PCT/US2022/053797

§ 371 Date: Jun. 24, 2024

Related U.S. Application Data
(60) Provisional application No. 63/293,670, filed on Dec. 24, 2021.
(60) Provisional application No. 63/293,674, filed on Dec. 24, 2021.
(60) Provisional application No. 63/293,677, filed on Dec. 24, 2021.
(60) Provisional application No. 63/293,681, filed on Dec. 24, 2021.

(51) Int. Cl. B61B 13/08; B60L 13/03; B60L 13/10; H02K 29/03; H02K 41/03

(52) U.S. Cl. CPC B61B 13/08; B60L 13/03; B60L 13/10; H02K 29/03; H02K 41/03; H02K 2201/03

(57) ABSTRACT

A vehicle with offset propulsion motors is provided. The vehicle comprises: a body; and a plurality of propulsion motors at a side of the body, arranged in a line about parallel to a movement axis of the body. Displacements between adjacent propulsion motors along the movement axis are selected according to an electrical period of poles of the plurality of propulsion motors, and an offset distance. The offset distance is determined by dividing the electrical period into the offset distance to determine a remainder. The electrical period divided by the remainder is about equal to a number of the plurality of propulsion motors divided by a given integer value that is less than the number of the plurality of propulsion motors, and produces a largest common divider between the given integer value and the number of the plurality of propulsion motors of “1”.

### CROSS-REFERENCE TO RELATED APPLICATIONS

The present application claims priority from U.S. Patent Application No. 63/293,670, filed on Dec. 24, 2021, and from U.S. Patent Application No. 63/293,674, filed on Dec. 24, 2021, and from U.S. Patent Application No. 63/293,677 filed on Dec. 24, 2021, and from U.S. Patent Application No. 63/293,681, filed on Dec. 24, 2021, the contents of all of which are incorporated herein by reference.

### BACKGROUND

The constraints of a transportation system that seeks to promote high speed, high efficiency, and high-power density, impose challenges that are not present in the state of the art, in particular to propel a payload and/or a vehicle along a track using a propulsion motor, and one or more of guide and levitate the propulsion motor relative to the track.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a view of a high-speed transport system that includes a track and track segments, according to non-limiting examples.

FIG. 2A depicts a perspective view of a homopolar linear synchronous motor, according to non-limiting examples.

FIG. 2B depicts a front view of the homopolar linear synchronous motor, according to non-limiting examples.

FIG. 2C depicts a calculation of force ripple of a propulsion motor as a propulsion motor is propelled along a track, according to non-limiting examples.

FIG. 3 depicts a schematic side view of a top or bottom half of a propulsion motor, according to non-limiting examples.

FIG. 4A depicts a schematic side view of a top or bottom half of a propulsion motor with an end ferromagnetic core being shorter than remaining ferromagnetic cores, according to non-limiting examples.

FIG. 4B depicts a schematic side view of a top or bottom half of a propulsion motor with a plurality of successive end ferromagnetic core increasing in height from a respective end towards a center of the propulsion motor, according to non-limiting examples

FIG. 5A depicts a schematic side view of a top or bottom half of a propulsion motor with an end ferromagnetic core including a step, according to non-limiting examples.

FIG. 5B depicts a schematic side view of a top or bottom half of a propulsion motor with a at least one of successive end ferromagnetic cores being shorter than remaining ferromagnetic cores, and with a last of end ferromagnetic cores including a step, according to non-limiting examples.

FIG. 6A depicts a schematic side view of a top or bottom half of a propulsion motor with an end ferromagnetic core being narrower than remaining ferromagnetic cores, according to non-limiting examples.

FIG. 6B depicts a schematic side view of a top or bottom half of a propulsion motor with a plurality of successive end ferromagnetic cores increasing in width from a respective end towards a center of the propulsion motor, according to non-limiting examples

FIG. 7A depicts a schematic side view of a top or bottom half of a propulsion motor with an end ferromagnetic core including a chamfer, according to non-limiting examples.

FIG. 7B depicts a schematic side view of a top or bottom half of a propulsion motor with a at least one of successive end ferromagnetic cores being shorter than remaining ferromagnetic cores, and with a last end ferromagnetic core including a chamfer, according to non-limiting examples.

FIG. 7C depicts a schematic side view of a top or bottom half of a propulsion motor with a plurality of successive end ferromagnetic cores including chamfers which cause the successive end ferromagnetic cores to increase in volume of ferromagnetic material from a respective end towards a center of the propulsion motor, according to non-limiting examples.

FIG. 8A depicts a schematic side view of a top or bottom half of a propulsion motor with an end ferromagnetic core including a hollow portion to decrease a volume of ferromagnetic material relative to remaining ferromagnetic cores, according to non-limiting examples.

FIG. 8B depicts a schematic side view of a top or bottom half of a propulsion motor with a plurality of successive end ferromagnetic core with hollow portions of decreasing volume, which cause the successive end ferromagnetic cores to increase in volume of ferromagnetic material from a respective end towards a center of the propulsion motor, according to non-limiting examples.

FIG. 9 depicts a graph which compares ripple force of a propulsion motor with uniform ferromagnetic cores, to ripple force of propulsion motors having with one or more end ferromagnetic cores shaped to provide one or more of increasing magnetic permeance or decreasing magnetic reluctance from an end towards a center of the propulsion motors, according to non-limiting examples.

FIG. 10A depicts a portion of a propulsion motor having flat armature coils, according to non-limiting examples.

FIG. 10B depicts a portion of a propulsion motor having stepped armature coils, according to non-limiting examples.

FIG. 11A depicts a portion of a propulsion motor including ferromagnetic cores that are skewed or angled relative to a movement axis, forming non-perpendicular angles with the movement axis, according to non-limiting examples.

FIG. 11B depicts a portion of a propulsion motor including slot wedges and ferromagnetic cores that are notches at respective outer ends, according to non-limiting examples.

FIG. 11C depicts a portion of a propulsion motor including ferromagnetic cores that are shaped to include bars that extend along one or more of the respective outer ends, according to non-limiting examples.

FIG. 11D depicts a portion of a propulsion motor including ferromagnetic cores that are both notched at respective outer ends and are shaped to include bars that extend along one or more of the respective outer ends, according to non-limiting examples.

FIG. 12A depicts a side view of a propulsion motor (and track therefor) that include field coils offset from one another along a movement axis, according to non-limiting examples.

FIG. 12B depicts a top view of a propulsion motor (and a portion of a track therefor) that include field coils in which opposite ends along the movement axis are narrower relative to respective centers of the field coils, according to non-limiting examples.

FIG. 12C depicts a top view of a propulsion motor (and a portion of a track therefor) that include field coils in which opposite ends along the movement axis are narrower relative to respective centers of the field coils, and in which complementary ferromagnetic devices are included at the opposite ends, according to non-limiting examples.

FIG. 13A depicts a perspective view of a propulsion motor and track segments, to show widths and a track pitch of the track segments, according to non-limiting examples.

FIG. 13B depicts a graph of ripple force as a function of a ratio of track segment width to half of track pitch, according to non-limiting examples.

FIG. 14 depicts a symmetric configuration and an asymmetric configuration arrangement of track segments, in which pitch between the track segments is varied in the asymmetric configuration, according to non-limiting examples.

FIG. 15A, FIG. 15B, FIG. 15C, FIG. 15D, and FIG. 15E depict track segments which include one or more of steps, rounded corners, and notches to one or more of at least partially increase magnetic permeance or at least partially decrease magnetic reluctance from about a propulsion motor-facing end to an opposite end, perpendicular to a movement axis of the propulsion motor, according to non-limiting examples.

FIG. 16A depicts a vehicle with four propulsion motors, according to non-limiting examples.

FIG. 16B depicts adjacent propulsion motors to show displacement therebetween and an electrical period, according to non-limiting examples.

### DETAILED DESCRIPTION

The constraints of a transportation system that seeks to promote high speed, high efficiency, and high-power density, impose challenges that are not present in the state of the art, in particular to propel a payload and/or a vehicle along a track using a propulsion motor, and one or more of guide and levitate the propulsion motor relative to the track.

In particular, propulsion motors may be attached to a payload to form a vehicle. The propulsion motors propel the payload and/or the vehicle along a track and generally include: at least one ferromagnetic core; a magnetic flux inducing device (e.g. such as field coils and/or magnets) to induce a first magnetic flux in the at least one ferromagnetic core along a magnetic flux pathway formed in combination with ferromagnetic track segments of the track; armature coils to induce a varying second magnetic flux in the at least one ferromagnetic core perpendicular to the magnetic flux pathway, thereby inducing a propulsion force perpendicular to the magnetic flux pathway in combination with the ferromagnetic track segments of the track. It is hence understood that ferromagnetic cores of a propulsion motor are generally adjacent to, and/or between the ferromagnetic track segments of the track; for example, the ferromagnetic track segments of the track may be C-shaped, and the ferromagnetic cores of the propulsion motor may be generally block shaped and/or rectangular, and the like, in cross-section to fit between opposing ends of the C-shaped ferromagnetic track segments. However, the ferromagnetic track segments and the ferromagnetic cores may be any suitable respective complementary shapes.

Regardless of shapes of the ferromagnetic track segments and the ferromagnetic cores, force ripple may occur as the propulsion motor moves across the ferromagnetic track segments. For example, force ripple may occur due to a longitudinal end effect due to a finite length of the propulsion motor interacting with the track segments at front and rear ends of the propulsion motor that results in an asymmetric reluctance force. However, force ripple may further occur due to phase winding asymmetry which may be caused by unbalanced Lorentz forces between different phases of the armature coils and/or which may be caused by inconsistencies between the phases at the ends of the propulsion motor. force ripple may yet further occur due to a space harmonics slotting effect due to the gaps between the ferromagnetic cores.

Indeed, each of these effects may cause different harmonics of force ripple, which may occur simultaneously at the propulsion motor.

In particular, first order periodic force ripple may occur due to an end effect that occurs because of a finite length of a propulsion motor. Second order periodic force ripple may occur due to asymmetric Lorentz force from flat armature windings. Higher order (e.g. 3^{rd} order, or higher) periodic force ripple may occur due to slotting, or continuous variation of reluctance, and the like of ferromagnetic cores of a propulsion motor and/or track segments.

In particular, end effect force ripple may generate first order harmonic of force ripple. When a propulsion motor moves along a track, a front end of a propulsion motor “constantly” interacts with a “next” track segment approaching the front end, and a back end of a propulsion motor “constantly” interacts with a “last” track segment that the propulsion motor is passing and/or leaving behind. This transition produces variation of reluctance once per electrical period. For this reason, end effect force ripple may generate first order harmonic of force ripple at a propulsion motor. As descried herein, to reduce force ripple due to the end effect, a “smooth” variation of reluctance at an end of a propulsion motor (e.g. at both a front end and back end) may be provided by modifying ferromagnetic shapes of ferromagnetic cores of the propulsion motor. Such “smoothed” reluctance reduces the rate of change of reluctance force at the ends, and thus may reduce the first order harmonic of force ripple (e.g. force is proportional to rate of change of reluctance).

Asymmetric placement of armature windings (e.g. flat shape winding) produces even order harmonics (e.g. second order periodic force ripple), for example due Lorentz forces at each of three phase windings are being different due to different leakage flux in a slot. Such force ripple may be reduced by using stepped armature windings, rather than flat armature windings, as described herein.

Respective gaps between the ferromagnetic cores the track segments may produce higher order (third order and higher) force ripple due reluctance variation that may occur more than once per electrical cycle. This force ripple happens regardless of the end effect (i.e. regardless of whether a propulsion motor has finite length or “infinite” length (as may be the case with rotary motors). Such force ripple may be reduced by shaping track segments, as described herein and/or by shaping ferromagnetic cores of a propulsion motor to include notches and/or other features as described herein.

Force ripple may further be reduced by positioning a plurality of propulsion motors at a vehicle, as described herein.

As such, provided herein are various topologies (e.g. configurations) to reduce force ripple at a propulsion motor, and which may be independent of the complementary shapes of the ferromagnetic track segments and the ferromagnetic cores.

In one example, force ripple may be reduced by providing, at a propulsion motor, ferromagnetic cores arranged along a movement axis (e.g. a longitudinal axis), the ferromagnetic cores including one or more end ferromagnetic cores located at an end of the propulsion motor and/or the movement axis, the one or more end ferromagnetic cores shaped to provide one or more of increasing magnetic permeance or decreasing magnetic reluctance from the end of the movement axis towards a center of the propulsion motor and/or the movement axis. For example, the one or more end ferromagnetic cores may comprise an increasing volume of ferromagnetic material from the end of the propulsion motor and/or the movement axis towards the center of the propulsion motor and/or the movement axis using one or more of: steps; chamfering; an increase in one or more of height, width, and volume, relative to one another, from the end of the movement axis towards the center of the movement axis, and the like. Regardless, the initial interaction of the end ferromagnetic cores (e.g. shaped to provide one or more of increasing magnetic permeance or decreasing magnetic reluctance from the end of the movement axis towards a center of the movement axis with the ferromagnetic track segments), allows the propulsion force produced by the propulsion motor and the ferromagnetic track segments to increase less abruptly at the ends, than if the ferromagnetic cores all had uniform variation of reluctance, thereby leading to a reduction in force ripple due to the longitudinal end effect.

In another example, force ripple may be reduced by providing, at a propulsion motor, stepped armature coils. Such stepped armature coils reduce the unbalanced Lorentz forces caused by phase winding asymmetry.

In another example, force ripple may be reduced by providing, at a propulsion motor, ferromagnetic cores that are one or more of: skewed or angled relative to the movement axis, forming non-perpendicular angles with the movement axis; notched at respective outer ends; and shaped to include bars that extend along one or more of the respective outer ends. Such skewing tends to reduce force ripple due to displacement of space harmonics along a width of a propulsion motor; such notches tend to reduce force ripple by minimizing an abrupt change of magnetic reluctance, and notches may further tend to reduce peak of force ripple due to reduced airgap flux density.

In another example, force ripple may be reduced by providing a track for a propulsion motor having a given track pitch, the track comprising plurality of track segments relative to which the propulsion motor is propelled by the plurality of track segments acting as a rotor component of a magnetic machine and the propulsion motor acting as a stator component of the magnetic machine, the plurality of track segments and the propulsion motor, together forming a homopolar linear synchronous machine. In particular, force ripple may be reduced by selecting a ratio of a width of a track segment along the track, to a half of a given track pitch, that is about 0.7.

In another example, force ripple may be reduced by providing a vehicle comprising: a body; and a plurality of propulsion motors at a side of the body, arranged about parallel to a movement axis of the body, wherein displacements between adjacent propulsion motors varies along the movement axis.

Indeed, such devices may be combined at a high-speed transport system that includes the track with the track segments, and a vehicle with one or more propulsion motors attached to the vehicle.

An aspect of the specification provides a propulsion motor comprising: ferromagnetic cores arranged along a movement axis, the ferromagnetic cores including one or more end ferromagnetic cores located at an end of the movement axis, the one or more end ferromagnetic cores shaped to provide one or more of increasing magnetic permeance or decreasing magnetic reluctance from the end of the movement axis towards a center of the movement axis; armature coils located around the ferromagnetic cores; and at least one field coil around one or more of the armature coils and the ferromagnetic cores.

Another aspect of the specification provides a track for a propulsion motor, the track comprising: a plurality of track segments relative to which the propulsion motor is propelled by the plurality of track segments acting as a rotor component of a magnetic machine and the propulsion motor acting as a stator component of the magnetic machine, the plurality of track segments and the propulsion motor, together forming a homopolar linear synchronous machine, wherein a ratio of a width of a track segment along the track, to a half of track pitch of the track, is about 0.7.

Another aspect of the specification provides a vehicle comprising: a body; and a plurality of propulsion motors at a side of the body, arranged in a line about parallel to a movement axis of the body, wherein displacements between adjacent propulsion motors along the movement axis are selected according to an electrical period of poles of the plurality of propulsion motors, and an offset distance, wherein the offset distance is determined from dividing the electrical period into the offset distance to determine a remainder, and wherein the electrical period divided by the remainder is about equal to a number of the plurality of propulsion motors divided by a given integer value that is less than the number of the plurality of propulsion motors, and produces a largest common divider between the given integer value and the number of the plurality of propulsion motors of “1” (e.g. the number “one”).

Another aspect of the specification provides a method comprising: for plurality of propulsion motors at a side of a body of a vehicle, the plurality of propulsion motors arranged in a line about parallel to a movement axis of the body, determining displacements between adjacent propulsion motors along the movement axis according to an electrical period of poles of the plurality of propulsion motors, and an offset distance, wherein the offset distance is determined by dividing the electrical period into the offset distance to determine a remainder, and wherein the electrical period divided by the remainder is about equal to a number of the plurality of propulsion motors divided by a given integer value that is less than the number of the plurality of propulsion motors, and produces a largest common divider between the given integer value and the number of the plurality of propulsion motors of “1” (e.g. the number “one”).

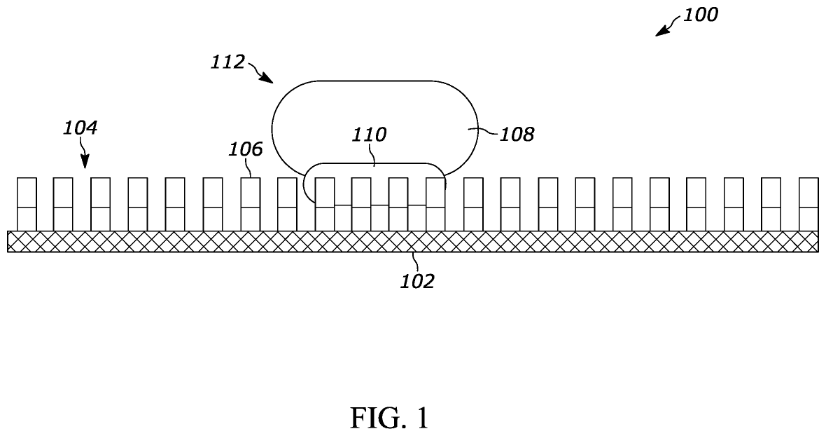

Attention is directed to FIG. 1 which schematically depicts a top view of a high-speed transport system 100. As depicted, the system 100 includes a fixed surface and/or a wall 102 (depicted in cross-section) which supports a track 104 comprising track segments 106 spaced periodically along the wall 102. In some examples, the wall 102 may be a wall, and/or an interior, of a tube, which may be evacuated and/or at least partially evacuated using vacuum pumps (not depicted) and the like, to form a low-pressure environment. However, in other examples, the tube may not be evacuated and/or the wall 102 and the track 104 are not in a low-pressure environment. Furthermore, the wall 102 may not be a wall of a tube, but may be a wall of any suitable structure and/or fixed surface which supports the track 104. The wall 102 may further comprise corners to which the track segments 106 may be mounted. Furthermore, the high-speed transport system 100 may be deployed on land, underground, overland, overwater, underwater, and the like.

As depicted, the system 100 includes a payload 108, and the like, for transporting cargo and/or passengers, and the like, and/or any other suitable payloads. The payload 108 may be aerodynamically shaped. The system 100 further includes at least one propulsion motor 110 attached to the payload 108 which interact with the track segments 106 to move the payload 108 along the track 104. Any suitable number of propulsion motors 110 may be attached to the payload 108 in any suitable configuration. Indeed, together, the payload 108 and the any suitable number of propulsion motors 110 may together form a vehicle 112 that is propelled along the track 104 by the propulsion motor 110. Similarly, the track 104 and the track segments 106 may be located on one or more sides of a tube, and the like, that include the wall 102, with any geometry of a propulsion motor 110 attached to the payload 108 adjusted accordingly; put another way, the track 104 may comprise a plurality to tracks 104 positioned to interact with a plurality of propulsion motors 110 attached to the payload 108 in any suitable configuration.

In general, the track segments 106 and the propulsion motor 110, form a homopolar linear synchronous machine. The propulsion motor 110 may be attached to the payload 108 in any of one or more orientations, such as on the top, bottom, and side of the payload 108, so long as a corresponding track segment 106 is substantially connected to the wall 102 in an orientation that allows the propulsion motor 110 to pass through and/or adjacent to a track segment 106 (e.g. depending on the configuration of the track segments 106 and ferromagnetic cores of the propulsion motor 110) in a direction of motion. The track segments 106 may be attached to the wall 102 in any suitable orientation, so long as the propulsion motor 110 has a substantially matching orientation to allow the propulsion motor 110 to pass through and/or adjacent to the track segments 106.

In particular, ferromagnetic cores of the propulsion motor 110 should be positioned relative to the track segments 106 of the track 104 in a consistent manner, as the propulsion motor 110 moves along the track 104. As such, in addition to at least one propulsion motor 110, the payload 108 and/or the vehicle 112 may be provided with one or more of: at least one guidance actuator, to laterally control the position of the ferromagnetic cores of the propulsion motor 110 “left” and “right” relative to the track segments 106 of the track 104; and/or at least one levitation actuator to levitate the propulsion motor 110 (e.g. oppose gravity), relative to the track, to control the position of the propulsion motor 110 “up” and “down” relative to the track segments 106 of the track 104, all while the propulsion motor 110 propels the payload 108 along the track 104. However, in some examples, at least the levitation actuator may be replaced with mechanical devices, such as wheels at the vehicle 112.

Hence, while not depicted, the system 100 may hence further comprise a suspension and/or location system to suspend and/or locate the vehicle 112 and/or the payload 108 and/or the propulsion motor 110 relative to the track segments 106. Such a suspension and/or location system may be mechanical (e.g. wheels and a corresponding track therefor), and/or electromagnetic (e.g. a maglev system), and/or of any other suitable configuration, and which may include, but is not limited to, the aforementioned levitation actuator and corresponding ferromagnetic levitation segments of the track 104 (not depicted) with which the aforementioned levitation actuator interacts to levitate the vehicle 112 and/or the payload 108 and/or the propulsion motor 110.

Similarly, while not depicted, the system 100 may further comprise a guidance system to guide and/or steer the vehicle 112 and/or the payload 108 and/or the propulsion motor 110 relative to the track segments 106, and/or onto other walls (e.g. of other tubes) that connect to the wall 102. Such a guidance system may include, but is not limited to, the aforementioned guidance actuator and corresponding ferromagnetic guidance segments of the track 104 (not depicted) with which the aforementioned guidance actuator interacts to steer the vehicle 112 and/or the payload 108 and/or the propulsion motor 110.

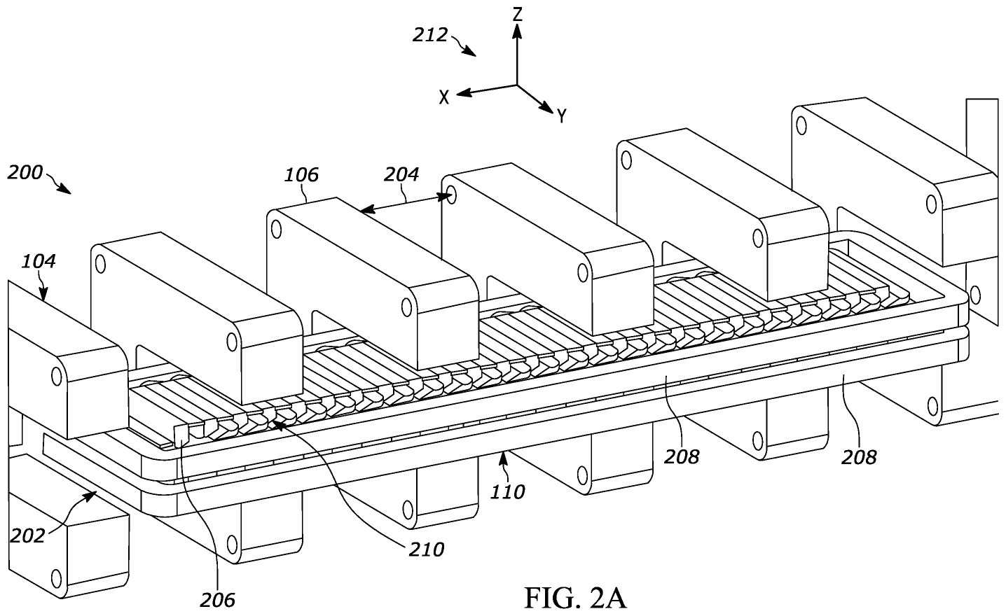

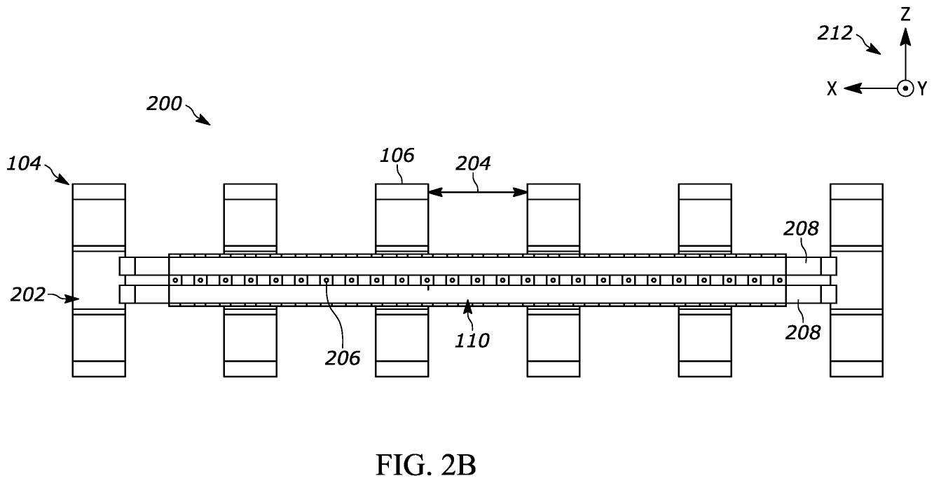

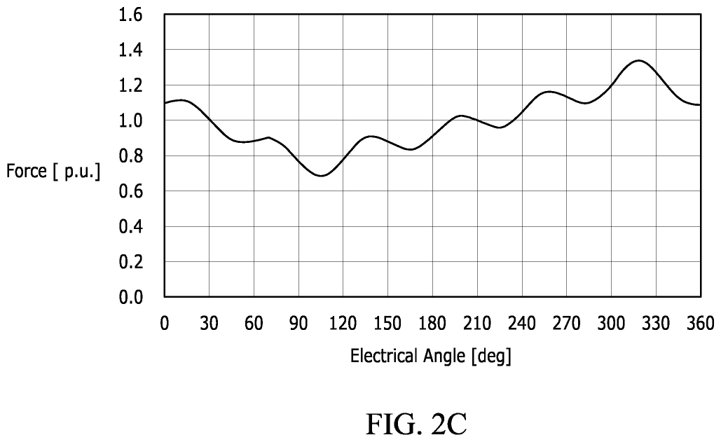

Attention is next directed to FIG. 2A and FIG. 2B which respectively depict perspective view and a side view of a homopolar linear synchronous machine (HLSM) 200 according to present examples. In particular, FIG. 2A depicts a perspective view of a portion of the track 104, including a portion of the track segments 106 and an example propulsion motor 110. As depicted, the track segments 106 may be substantially C-shaped shaped, and the like, such that a propulsion motor 110 may pass through a center “hollow” portion 202 of a track segment 106, as seen in both FIG. 2A and FIG. 2B. As depicted, the propulsion motor 110 is passing through a plurality of track segments 106. The track 104, and specifically the track segments 106, may function as a “stator” of the HLSM 200, and the propulsion motor 110 may function as a “rotor” of the HLSM 200, such that, together, the track 104 (e.g. the track segments 106) and the propulsion motor 110 form the HLSM 200.

As depicted, the HLSM 200, as described herein, may include two or more laterally offset track segments 106, such that there is a gap 204 between adjacent track segments 106. Hence, the track segments 106 are generally magnetically salient, such that a varying magnetic flux may be produced across the track segments 106 and the gaps 204, for example by at least a magnetic flux inducing device of the propulsion motor 110, such as at least one field coil, described in more detail below, and/or a at least one magnet.

Such magnetic flux may be about constant in a track segment 106, and the resulting magnetic flux in the gap 204 varies, relative to the flux in a track segment 106, in a direction of motion (e.g. along the track 104).

In particular, the propulsion motor 110 comprises at least one ferromagnetic core 206 having opposite ends joined by a body forming a magnetic flux pathway between the opposite ends. For example as depicted, the propulsion motor 110 comprises a plurality of ferromagnetic cores 206, arranged along the track 104 and/or along a longitudinal axis of the propulsion motor 110, that are block shaped and/or rectangular in cross-section that are shaped to fit into the hollow portions 202 of the track segments 106. The magnetic flux pathway formed by the at least one ferromagnetic core 206 is understood to complete a magnetic flux pathway formed in the track segments 106, for example, with each track segment 106 forming a respective portion of a magnetic flux pathway completed by respective ferromagnetic cores 206.

The propulsion motor 110 further comprises at least field coil 208 (e.g. a magnetic flux inducing device) to induce a first magnetic flux in the at least one ferromagnetic core 206 along the magnetic flux pathway. As depicted, the at least field coil 208 comprises a pair of field coils 208 that induce a first magnetic flux in the at least one ferromagnetic core 206 along the magnetic flux pathway and through respective track segments 106; however, the at least field coil 208 may be replaced by any suitable combination of magnets, for example embedded in the ferromagnetic cores 206, and/or the propulsion motor 110 may comprise any suitable combination of field coils and magnets (e.g. and/or any other suitable combination of one or more magnetic flux inducing devices) to induce a first magnetic flux in the at least one ferromagnetic core 206 along the magnetic flux pathway

The propulsion motor 110 further comprises armature coils 210 (as best seen in FIG. 2A) to induce a varying second magnetic flux in the at least one ferromagnetic core 206 perpendicular to the magnetic flux pathway formed by the at least one ferromagnetic core 206 and the track segments 106, to induce a propulsion force perpendicular to the magnetic flux pathway. In general, the armature coils 210 of the propulsion motor 110 may generate the second magnetic flux through the track segments 106 that results in pole pairs (e.g. a sequence of magnetically-polarized regions) which interact with the magnetic flux, generated by the at least one field coil 208 (e.g. and/or least one magnetic flux inducing devices), to propel the propulsion motor 110 along the track 104.

In particular, as depicted, the track segments 106 are arranged such that the hollow portions 202 of the track segments 106 form a substantially continuous path for the propulsion motor 110, and specifically the propulsion motor 110, to move relative to the track segments 106 and/or the track 104. Hence, a track 104 and/or track segments 106, may be substantially fixed relative to the propulsion motor 110 of the HLSM 200. Together, the track 104 and the propulsion motor 110 comprise a propulsion system for moving the payload 108 and/or the vehicle 112 relative to the wall 102, in either direction along the track 104. In particular, the propulsion motor 110 is propelled along the track 104 using magnetic flux produced by the propulsion motor 110, as described, for example, in Applicant's co-pending application titled “HOMOPOLAR LINEAR SYNCHRONOUS MACHINE” having PCT Patent Application No. PCT/US2019/051701, filed Sep. 18, 2019, and which claims priority from U.S. Patent Application No. 62/733,551, filed Sep. 19, 2018, and the contents of each are incorporated herein by reference.

However, the HLSM 200 may comprise track segments and ferromagnetic cores of any suitable shape and/or configuration. In particular, other examples of track segments and ferromagnetic cores is described, for example, in Applicant's co-pending application titled “PROPULSION MOTOR TOPOLOGIES” having U.S. Patent Application No. 63/293,677, filed Dec. 24, 2022, the entire contents of which are incorporated herein by reference. For example, in some examples the HLSM 200 may comprise track segments which are not “C” shaped ferromagnetic cores, and which present flat surfaces to complementary shaped ferromagnetic cores of a propulsion motor such that the ferromagnetic cores of such a propulsion motor move along the flat surfaces of the ferromagnetic cores (e.g. and not in a hollow).

Hence, while hereafter examples are described with respect to the ferromagnetic cores 206 of the propulsion motor 110, and the track segments 106, having the shape depicted in FIG. 2A and FIG. 2B, it is understood that present examples may be adapted for ferromagnetic cores and track segments of any suitable shapes.

For clarity, an XYZ cartesian coordinate system 212 is depicted in FIG. 2A and FIG. 2B, showing a convention that will be used throughout the present specification. For example, an “X” axis is understood to be along the track 104, a “Y” axis is understood to be in a “left” and “right” direction, lateral to the track 104, for example in a direction between backs of track segments 106 and hollow portions 202, and the “Z” axis is understood to be in an “up” and “down” direction.

FIG. 2C depicts a calculation of force ripple of the propulsion motor 110 as the propulsion motor 110 is propelled along the track 104, for example as a function of electrical angle of one phase of the armature coils 210. It is apparent that the interaction with the track segments 106, there may be several orders of force ripple harmonics, which may be mitigated by topologies of a propulsion motor, a track and/or a vehicle provided herein

While hereafter devices for reducing force ripple are described with respect to the propulsion motor 110, which does not have a common (e.g. iron) backplane for the ferromagnetic cores 206, devices for reducing force ripple are described herein may be adapted for propulsion motors 110 that have a common (e.g. iron) backplane.

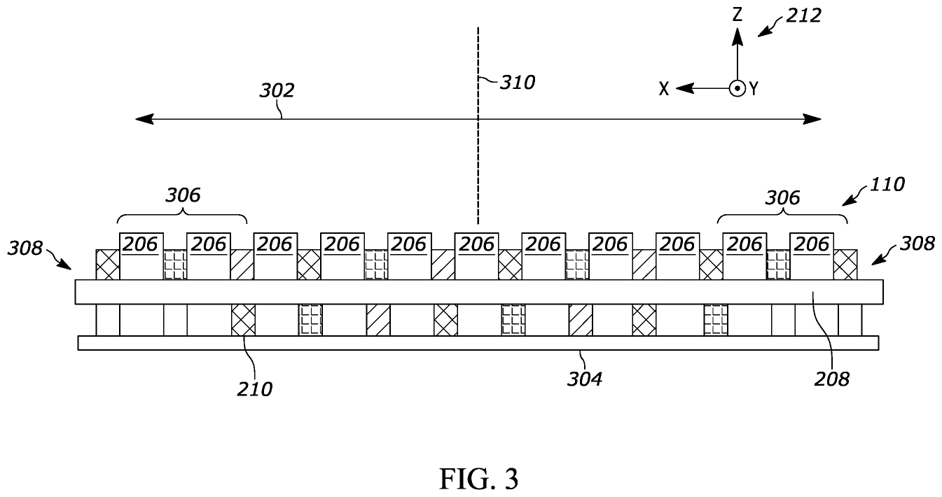

Attention is next directed to FIG. 3 which depicts a schematic side view of a top or bottom half of the propulsion motor 110. In particular FIG.3 is provided to illustrate that the propulsion motor 110 comprises the ferromagnetic cores 206 arranged along a movement axis 302 (e.g. a longitudinal axis of the propulsion motor 110), armature coils 210 located around the ferromagnetic cores 206, and at least one field coil 208 around one or more of the armature coils 210 and the ferromagnetic cores 206. Furthermore, while for illustrative purposes, eleven ferromagnetic cores 206 are depicted, it is understood that the propulsion motor 110 comprises any suitable number of ferromagnetic cores 206 (e.g. FIG. 2 depicts more than eleven ferromagnetic cores 206). Furthermore while, as depicted, the ferromagnetic cores 206 may extend through, and/or be supported by, a cold plate 304, such a cold plate 304 may be optional.

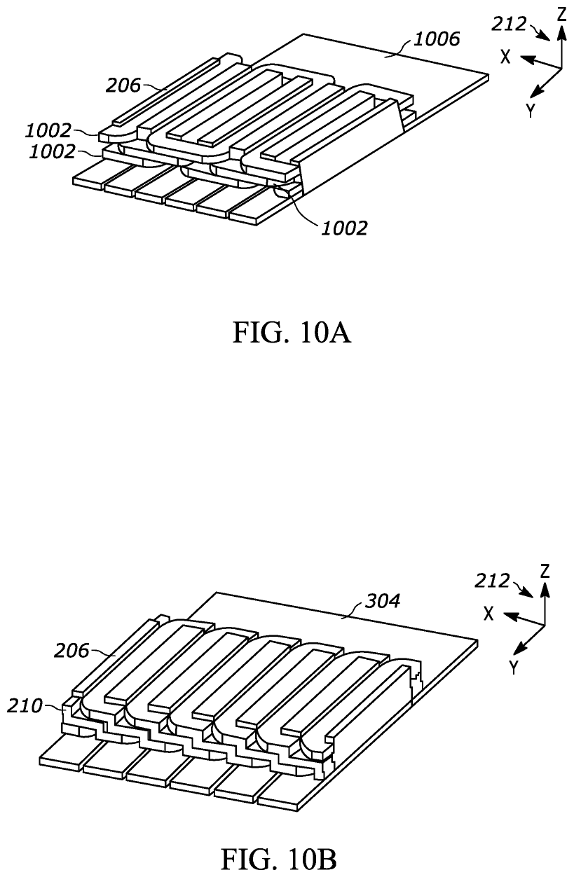

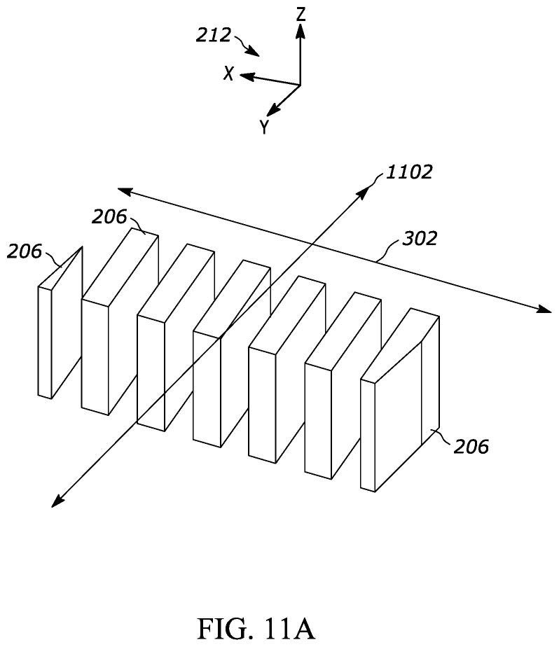

Similarly, while as depicted, only one of the armature coils 210 is indicated, it is understood that the propulsion motor 110 comprises any suitable number of armature coils 210. For example, as depicted, the armature coils 210 comprise three sets of armature coils 210 having different phases, and having a stepped configuration, each of which are around two adjacent ferromagnetic cores 206, with different armature coils 210 of different phases indicated by three types of shading of the armature coils 210. Details of the armature coils 210 are described below with respect to FIG. 10B.

As further indicated in FIG. 3, the ferromagnetic cores 206 may include one or more end ferromagnetic cores 306 located at an end 308 of the movement axis 302. For example, the propulsion motor 110 is understood to comprise opposite ends 308, for example along the movement axis 302 and which may comprise a front end 308 and a back end 308 depending on a direction of movement of the propulsion motor 110 (e.g. when the propulsion motor 110 is moving “left” in the plane of the page of FIG. 3, the leftmost end 308 of propulsion motor 110 may comprise a front end 308, and the rightmost end 308 may comprise a back end 308 and, similarly, when the propulsion motor 110 is moving “right” in the plane of the page of FIG. 3, the right most end 308 of propulsion motor 110 may comprise a front end 308, and the leftmost end 308 may comprise a back end 308).

As such, one or more the ferromagnetic cores 206 located at, or towards, the ends 308 may be referred to as an end ferromagnetic core 306. In particular, as described herein, while all the ferromagnetic cores 206 depicted in FIG. 3 are of a same shape, the one or more of the end ferromagnetic cores 306 may be shaped to provide one or more of increasing magnetic permeance or decreasing magnetic reluctance from an end 308 of the propulsion motor 110 and/or the movement axis 302 towards a center 310 of the propulsion motor 110 along the movement axis 302. Such increasing magnetic permeance and/or decreasing magnetic reluctance of the end ferromagnetic cores 306 generally reduce force ripple due to a longitudinal end effect of the propulsion motor 110, in which abrupt changes in force occur due to a lower magnetic permeance and/or higher magnetic reluctance of end ferromagnetic cores interacting with the track segments 106.

A number of the end ferromagnetic cores 306 that are shaped at an end 308 may vary, as described hereafter, and may comprise as few as one end ferromagnetic core 306, or may comprise more than one end ferromagnetic core 306 up to as many ferromagnetic cores 206 as are between the center 310 and a respective end 308. Hence, while two of the ferromagnetic cores 206 are indicated in FIG. 3 as being end ferromagnetic cores 306, a number of end ferromagnetic cores 306 may be as few as one or may be more than two.

In general, to provide one or more of increasing magnetic permeance or decreasing magnetic reluctance from an end 308 of the propulsion motor 110 and/or the movement axis 302 towards a center 310 of the propulsion motor 110 along the movement axis 302, one or more end ferromagnetic cores 306 may comprise an increasing volume of ferromagnetic material from an end 308 of the propulsion motor 110 and/or the movement axis 302, towards the center 310 of the movement axis 302. For example, the less ferromagnetic material at an end ferromagnetic core 306 (or any ferromagnetic core 206), the higher the magnetic permeance and the lower the magnetic reluctance, and, conversely, the more ferromagnetic material at an end ferromagnetic core 306 (or any ferromagnetic core 206), the lower the magnetic permeance and the higher the magnetic reluctance.

In particular, one end ferromagnetic core 306 may be one or more of shorter, narrower and of reduced volume relative to remaining ferromagnetic cores 206.

Similarly, a plurality of end ferromagnetic cores 306, located at an end 308 of the propulsion motor 110 and/or the movement axis 302 may increase in one or more of height, width, and volume, relative to one another, from the end 308 of the propulsion motor 110 and/or the movement axis 302 towards the center 310 of the propulsion motor 110 and/or the movement axis 302.

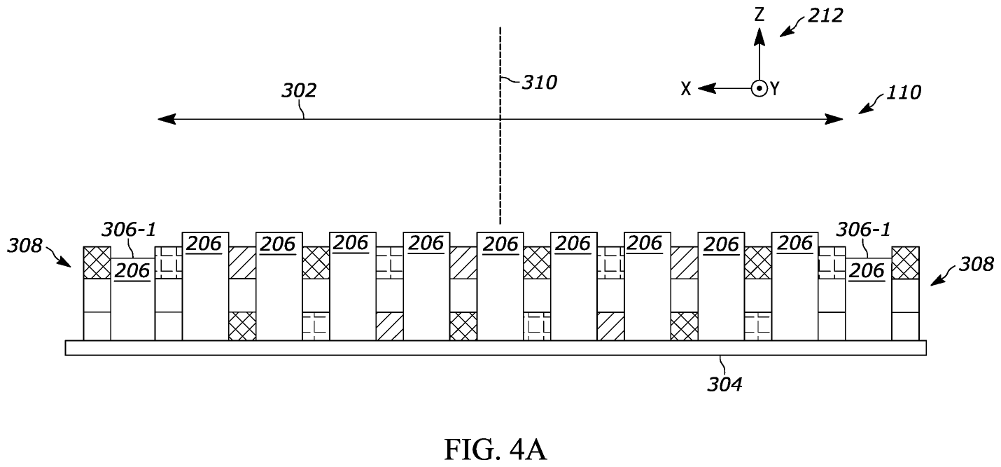

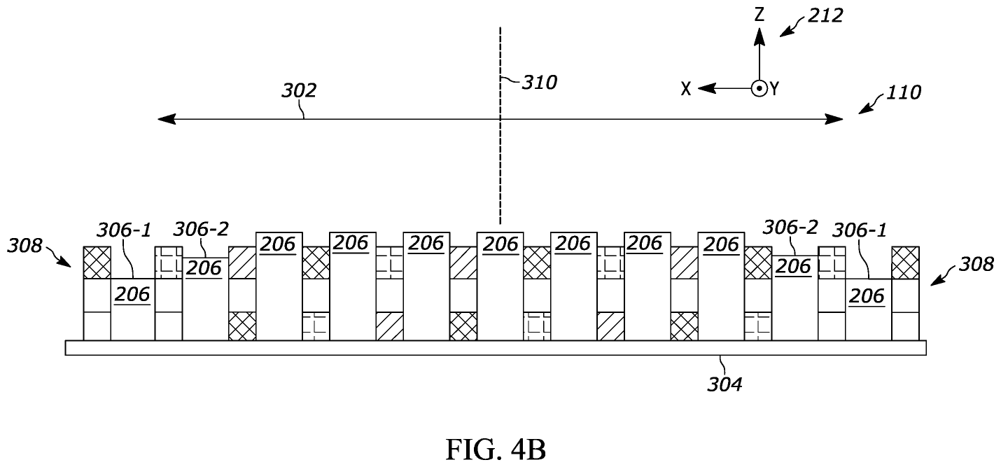

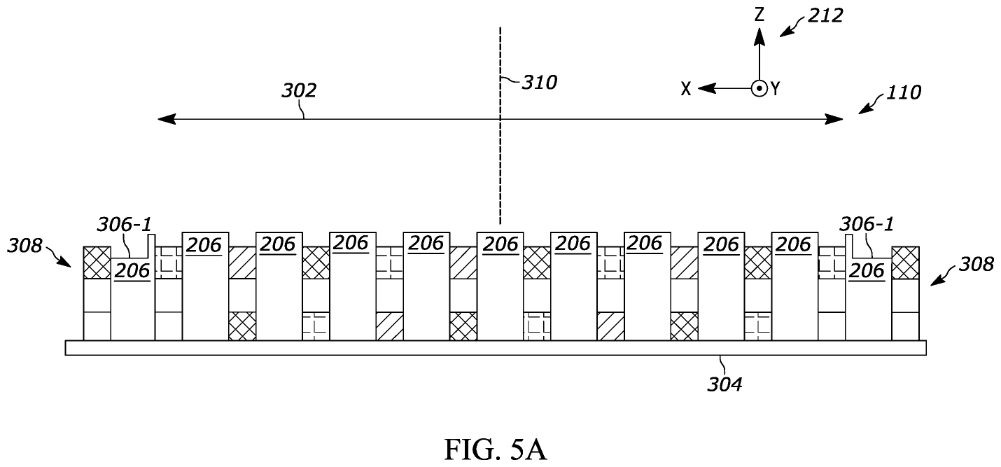

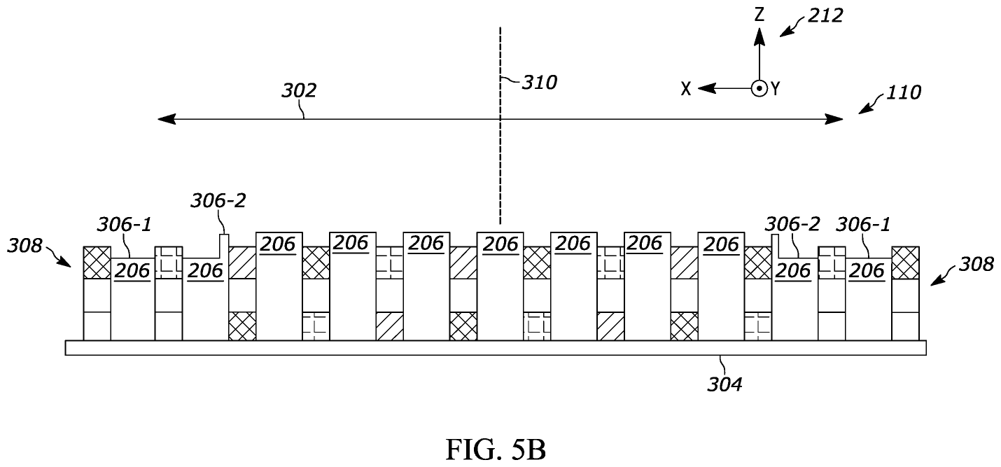

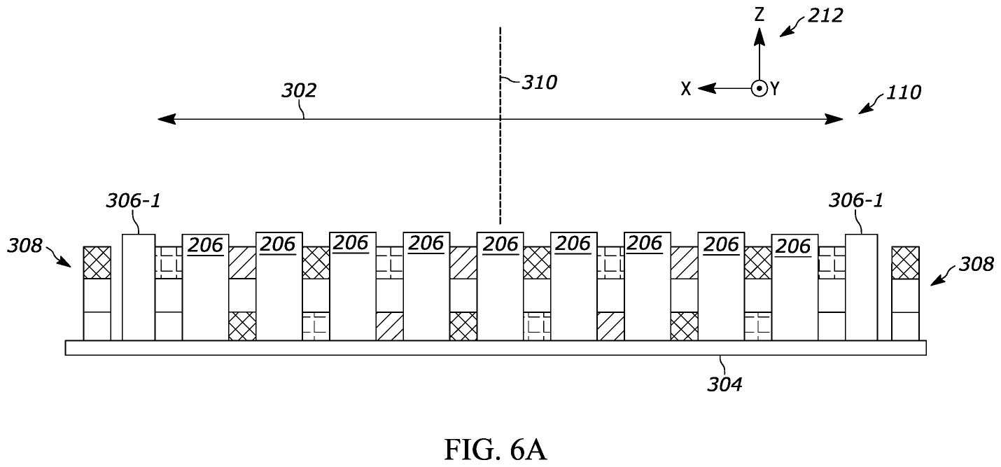

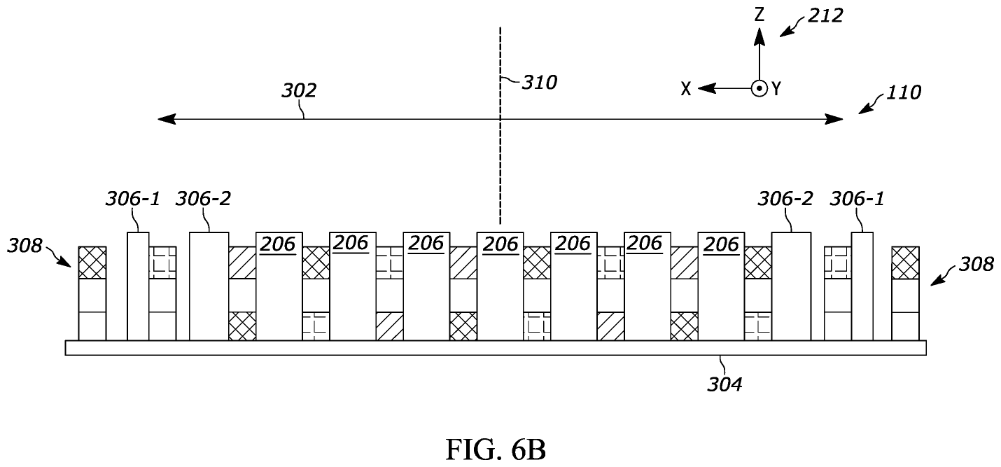

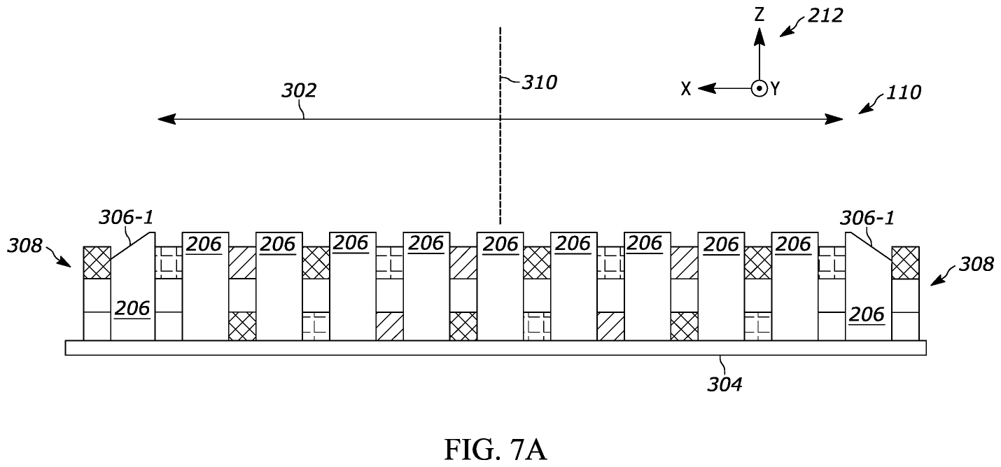

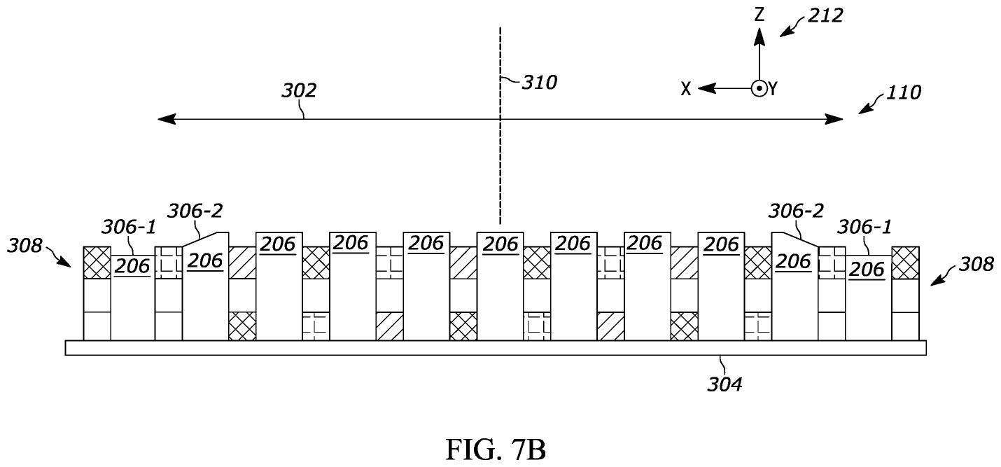

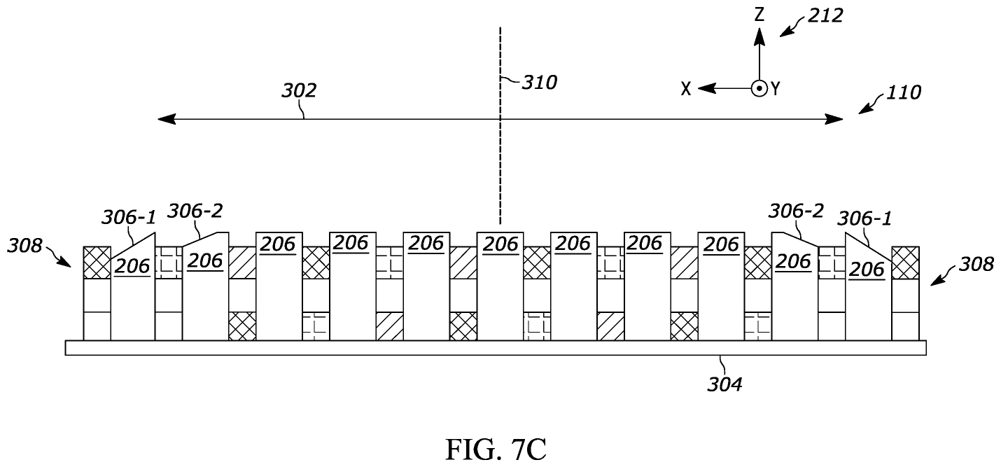

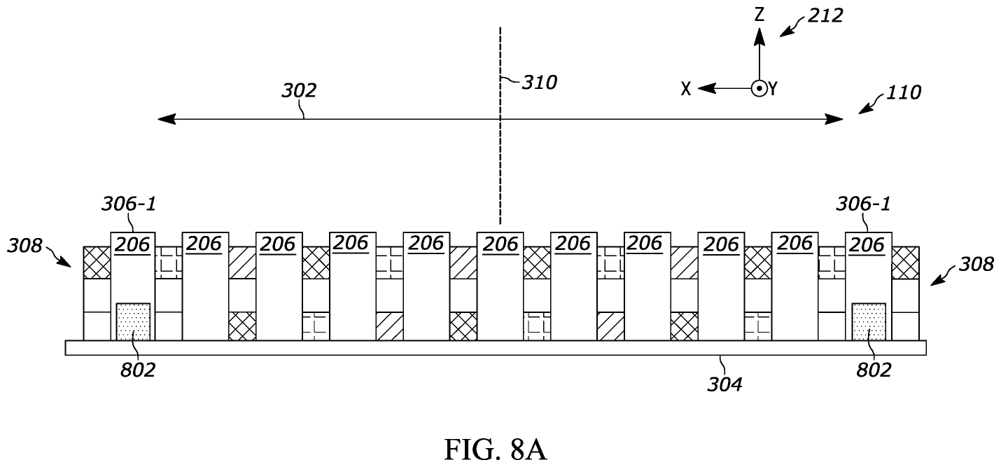

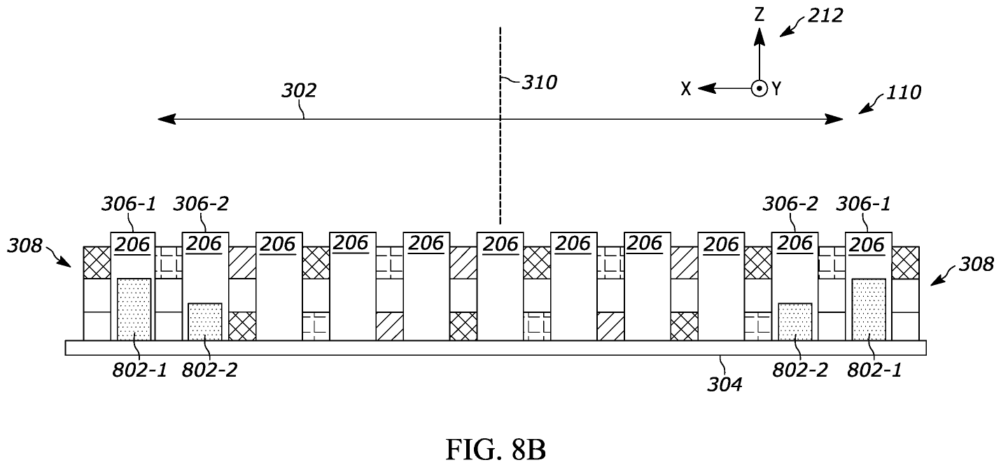

Examples of end ferromagnetic cores 306, shaped to provide one or more of increasing magnetic permeance or decreasing magnetic reluctance from an end 308 of the propulsion motor 110 and/or the movement axis 302 towards a center 310 of the propulsion motor 110 along the movement axis 302, are next described with respect to FIG. 4A, FIG. 4B, FIG. 5A, FIG. 5B, FIG. 6A, FIG. 6B, FIG. 7A, FIG. 7B, FIG. 7C, FIG. 8A, and FIG. 8B.

In FIG. 4A, FIG. 4B, FIG. 5A, FIG. 5B, FIG. 6A, FIG. 6B, FIG. 7A, FIG. 7B, FIG. 7C, FIG. 8A, and FIG. 8B, the field coil 208 is removed for clarity only, but is nonetheless understood to be present. Similarly, for simplicity, the armature coils 210 are not indicated, but are nonetheless understood to be present.

Furthermore, each of FIG. 4A, FIG. 4B, FIG. 5A, FIG. 5B, FIG. 6A, FIG. 6B, FIG. 7A, FIG. 7B, FIG. 7C, FIG. 8A, and FIG. 8B depict examples of end ferromagnetic cores 306 which comprise an increasing volume of ferromagnetic material from an end 308 of the propulsion motor 110 and/or the movement axis 302 towards a center 310 of the propulsion motor 110 along the movement axis 302.

Furthermore, each of FIG. 4A, FIG. 4B, FIG. 5A, FIG. 5B, FIG. 6A, FIG. 6B, FIG. 7A, FIG. 7B, FIG. 7C, FIG. 8A, and FIG. 8B depict examples of end ferromagnetic cores 306 that are one or more of shorter, narrower and of reduced volume relative to remaining ferromagnetic cores 206, with end ferromagnetic cores 306 that are closer to an end 308 being shorter, narrower and of reduced volume relative to adjacent end ferromagnetic cores 306 that are closer to the center 310.

Put another way, at least a portion of successive end ferromagnetic cores 306 may increase in magnetic permeance and/or decrease in magnetic reluctance and/or may increase in volume (e.g. of ferromagnetic material), relative to adjacent end ferromagnetic cores 306, and other ferromagnetic cores 206, from an end 308 of the propulsion motor 110 and/or the movement axis 302, towards the center 310 of the propulsion motor 110 and/or the movement axis 302.

Furthermore, arrangements of end ferromagnetic cores 306 and remaining ferromagnetic cores 206 in each of FIG. 4A, FIG. 4B, FIG. 5A, FIG. 5B, FIG. 6A, FIG. 6B, FIG. 7A, FIG. 7B, FIG. 7C, FIG. 8A, and FIG. 8B are understood to be symmetrical about the center 310; put another way, end ferromagnetic cores 306 at each end 308 are similar to each other. However, alternatively, a common (e.g. iron) backplane joins the ferromagnetic cores 306, for example in a region of the depicted cold plate 304.

Attention is next directed to FIG. 4A, which depicts the propulsion motor 110 adapted such that one end ferromagnetic core 306-1 located at respective ends 308 of the propulsion motor 110 and/or the movement axis 302 is shorter (e.g. along the “Z” axis of the coordinate system 212) relative to the remaining ferromagnetic cores 206. Put another way, one end ferromagnetic core 306-1 located at an end of the propulsion motor 110 and/or the movement axis 302 may be shorter relative to remaining ferromagnetic cores 206. Indeed, the one end ferromagnetic core 306-1 is further of reduced volume (e.g. of ferromagnetic material) relative to the remaining ferromagnetic cores 206 due to a reduced height.

With reference to FIG. 4B, the propulsion motor 110 may be adapted such that a plurality of end ferromagnetic cores 306-1, 306-2, located at respective ends 308 of the propulsion motor 110 and/or the movement axis 302 increase in height, (e.g. and volume), relative to one another, from the respective ends 308 of the propulsion motor 110 and/or the movement axis 302 towards the center 310 of the propulsion motor 110 and/or the movement axis 302. For example, the end ferromagnetic cores 306-1, which are closest to the respective ends 308, are shorter than next end ferromagnetic cores 306-2 closer to the center 310, and the next end ferromagnetic cores 306-2 are shorter than the remaining ferromagnetic cores 206 (e.g. successive end ferromagnetic cores 306 increase in height and/or volume towards the center 310). Hence, the end ferromagnetic cores 306-1, 306-2 increase in height from an end 308 towards the center 310. Put another way, a plurality of end ferromagnetic cores 306-1, 306-2 located at an end 308 the propulsion motor 110 and/or the movement axis 302 may increase in height (e.g. and volume) relative to one another, from the end 308 the propulsion motor 110 and/or the movement axis 302.

Put yet another way, at FIG. 4B, a plurality of end ferromagnetic cores 306-1, 306-2 located at respective ends 308 of the propulsion motor 110 and/or the movement axis 302 may be shorter than remaining ferromagnetic cores 206.

While the example of FIG. 4B is illustrated with two end ferromagnetic cores 306-1, 306-2, more than two end ferromagnetic cores 306 may increase in height from an end 308 towards the center 310. For example, three end ferromagnetic cores 306 may increase in height, or four end ferromagnetic cores 306 may increase in height, etc.

Attention is next directed to FIG. 5A, which depicts the propulsion motor 110 adapted such that an end ferromagnetic core 306-1 located at respective ends 308 of the propulsion motor 110 and/or the movement axis 302, include a step from a height, that is shorter than a respective height of the remaining ferromagnetic cores 206, to the respective height of the remaining ferromagnetic cores 206. The step is further oriented such that the smaller height is towards a of a respective end 308, at which the end ferromagnetic core 306-1 is located, and a larger height is towards the center 310, such that for the end ferromagnetic core 306-1 that includes the step, magnetic permeance increases and/or magnetic reluctance decreases in a direction from a respective end 308, at which the end ferromagnetic core 306-1 is located, towards the center 310.

Put another way, an end ferromagnetic core 306 may be located at an end 308 of the propulsion motor 110 and/or the movement axis 302 and which may include a step from a height, that is shorter than a respective height of the remaining ferromagnetic cores 206, to the respective height of the remaining ferromagnetic cores 206. Indeed, in FIG. 5A, it is understood that one end ferromagnetic core 306-1 is of reduced ferromagnetic volume relative to the remaining ferromagnetic cores 206 due to a step thereof and/or that one end ferromagnetic core 306-1 increases in ferromagnetic volume in a direction of a respective end 308, at which the end ferromagnetic core 306-1 is located, towards the center 310

Attention is next directed to FIG. 5B, which depicts the propulsion motor 110 adapted such that at least one of a plurality of end ferromagnetic cores 306-1, 306-2 located at respective ends 308 of the propulsion motor 110 and/or the movement axis 302 is shorter than remaining ferromagnetic cores 206, and a last of the plurality of end ferromagnetic cores 306-2, closest to the center 310, includes a step from a height of one or more previous end ferromagnetic cores 306-1 to a respective height of the remaining ferromagnetic cores 206. Hence, the example of FIG. 5B is similar to the examples of FIG. 4B and FIG. 5A, but a step is at an end ferromagnetic cores 306 that is closer to the center 310, with the other end ferromagnetic cores 306 being of a reduced height relative to the highest portion of a step. Put another way, a plurality of end ferromagnetic cores 206 may be located at an end 308 of the propulsion motor 110 and/or the movement axis 302, that are shorter than remaining ferromagnetic cores 206, and a last of the plurality of end ferromagnetic cores 306 closest to the center 310 may including a step from a height of one or more previous end ferromagnetic cores 306 to a respective height of the remaining ferromagnetic cores 206. Indeed, in FIG. 5B, it is understood that the end ferromagnetic core 306-1 is of reduced volume relative to the next ferromagnetic core 306-2, which is of reduced volume relative to the remaining ferromagnetic cores 206.

Furthermore, when there are three or more end ferromagnetic cores 306, the first two end ferromagnetic cores 306, closest to a respective end 308, may be shorter than remaining ferromagnetic cores 206, and a last of the plurality of end ferromagnetic cores 306, closest to the center 310, includes the step.

Attention is next directed to FIG. 6A, which depicts the propulsion motor 110 adapted such that one end ferromagnetic core 306-1 located at respective ends 308 of the propulsion motor 110 and/or the movement axis 302 is narrower (e.g. along the “X” axis of the coordinate system 212) relative to the remaining ferromagnetic cores 206. Put another way, one end ferromagnetic core 306-1 located at an end of the propulsion motor 110 and/or the movement axis 302 may be narrower relative to remaining ferromagnetic cores 206. Indeed, the one end ferromagnetic core 306-1 is further of reduced volume relative to the remaining ferromagnetic cores 206 due to a reduced height.

With reference to FIG. 6B, the propulsion motor 110 may be adapted such that a plurality of end ferromagnetic cores 306-1, 306-2, located at respective ends 308 of the propulsion motor 110 and/or the movement axis 302 increase in width, (e.g. and volume), relative to one another, from the respective ends 308 of the propulsion motor 110 and/or the movement axis 302 towards the center 310 of the propulsion motor 110 and/or the movement axis 302. For example, the end ferromagnetic cores 306-1 which are closest to the respective ends 308 are narrower than next end ferromagnetic cores 306-2 closer to the center 310, and the next end ferromagnetic cores 306-2 are narrower than the remaining ferromagnetic cores 206. Hence, the end ferromagnetic cores 306-1, 306-2 increase in width from an end 308 towards the center. Put another way, a plurality of end ferromagnetic cores 306-1, 306-2 located at an end 308 the propulsion motor 110 and/or the movement axis 302 may increase in width (e.g. and volume) relative to one another, from the end 308 the propulsion motor 110 and/or the movement axis 302.

Put yet another way, at FIG. 6B, a plurality of end ferromagnetic cores 306-1, 306-2 located at respective ends 308 of the propulsion motor 110 and/or the movement axis 302 may be narrower than remaining ferromagnetic cores 206.

While the example of FIG. 6B is illustrated with two end ferromagnetic cores 306-1, 306-2, more than two end ferromagnetic cores 306 may increase in width from an end 308 towards the center 310. For example, three end ferromagnetic cores 306 may increase width height, or four end ferromagnetic cores 306 may increase in width, etc.

Attention is next directed to FIG. 7A, which depicts the propulsion motor 110 adapted such that an end ferromagnetic core 306-1 located at respective ends 308 of the propulsion motor 110 and/or the movement axis 302, includes a chamfer from a height, that is shorter than a respective height of the remaining ferromagnetic cores 206, to the respective height of the remaining ferromagnetic cores 206. The chamfer is further oriented such that the smaller height is towards a respective end 308, and a larger height is towards the center 310, such that for the end ferromagnetic core 306-1 that includes the chamber, magnetic permeance increases and/or magnetic reluctance decreases in a direction from a respective end 308, at which the end ferromagnetic core 306-1 is located, towards the center 310.

Put another way, an end ferromagnetic core 306 may be located at an end 308 of the propulsion motor 110 and/or the movement axis 302 and which may include a chamfer from a height, that is shorter than a respective height of the remaining ferromagnetic cores 206, to the respective height of the remaining ferromagnetic cores 206. Indeed, in FIG. 7A, it is understood that one end ferromagnetic core 306-1 is of reduced volume relative to the remaining ferromagnetic cores 206 due to a chamfer thereof.

Attention is next directed to FIG. 7B, which depicts the propulsion motor 110 adapted such that at least one end ferromagnetic cores 306-1, of a plurality of ferromagnetic cores 306, located at a respective end 308 of the propulsion motor 110 and/or the movement axis 302, is shorter than remaining ferromagnetic cores 206, and a last of the plurality of end ferromagnetic cores 306-2, closest to the center 310, includes a chamfer from a height of previous end ferromagnetic cores 306 to a respective height of the remaining ferromagnetic cores 206. Hence, for example, the example of FIG. 7B is a combination of the example of FIG. 4B and the example of FIG. 7A. Similarly, more than one end ferromagnetic core 306 may be smaller in height than remaining ferromagnetic cores 206, prior to chamfered end ferromagnetic core 306.

Put another way, at least one end ferromagnetic core 306-1, of a plurality of ferromagnetic cores 306 located at a respective end 308 of the propulsion motor 110 and/or the movement axis 302, may be shorter than remaining ferromagnetic cores 206, a last of the plurality of end ferromagnetic cores 306 closest to the center 310 including a chamfer from a height of previous end ferromagnetic cores to a respective height of the remaining ferromagnetic cores. Indeed, in FIG. 7B, it is understood that a plurality of end ferromagnetic cores 306-1, 306-2 located at an end 308 the propulsion motor 110 and/or the movement axis 302 may increase in and volume relative to one another, from the end 308 the propulsion motor 110 and/or the movement axis 302.

Attention is next directed to FIG. 7C, which depicts the propulsion motor 110 adapted such a plurality of chamfered end ferromagnetic cores 306-1, 306-2 may be provided that increase in one or more of height, width and volume towards the center 310 of the propulsion motor 110 and/or the movement axis 302. The chamfers are understood to be oriented similar to the chamfers of the example of FIG. 7A or FIG. 7B. For example, as depicted, a first chamfered end ferromagnetic core 306-1, closest to a respective end 308, has a reduced height, and hence also a reduced volume, relative to a next chamfered end ferromagnetic core 306-2 closer to the center 310.

Attention is next directed to FIG. 8A, which depicts the propulsion motor 110 adapted such that an end ferromagnetic core 306-1, located at respective ends 308 of the propulsion motor 110 and/or the movement axis 302, includes a hollowed out portion 802 that reduces a volume of the end ferromagnetic core 306-1 relative to the remaining ferromagnetic cores 206. While the hollowed out portion 802 is visible in FIG. 8A, it is understood that the hollowed out portion 802 may be internal to the end ferromagnetic core 306-1

Attention is next directed to FIG. 8B, which depicts the propulsion motor 110 adapted such that a plurality of end ferromagnetic cores 306-1, 306-2, located at respective ends 308 of the propulsion motor 110 and/or the movement axis 302, include respective hollowed out portions 802-1, 802-2 that successively increases a volume of the plurality of end ferromagnetic cores 306-1, 306-2 from respective ends 308 of the propulsion motor 110 and/or the movement axis 302 towards the center 310. Put another way, successive hollowed out portions 802-1, 802-2 of successive end ferromagnetic cores 306-1, 306-2 decrease in volume from respective ends 308 of the propulsion motor 110 and/or the movement axis 302 towards the center 310, such that successive end ferromagnetic cores 306-1, 306-2 increase in volume of ferromagnetic material from respective ends 308 of the propulsion motor 110 and/or the movement axis 302 towards the center 310. Similar to other examples, such an increase in volume (e.g. of ferromagnetic material) and/or increase in magnetic permeance and/or decrease in magnetic reluctance due to such hollowed out portions 802 of end ferromagnetic cores 306 may occur for more than two end ferromagnetic cores 306.

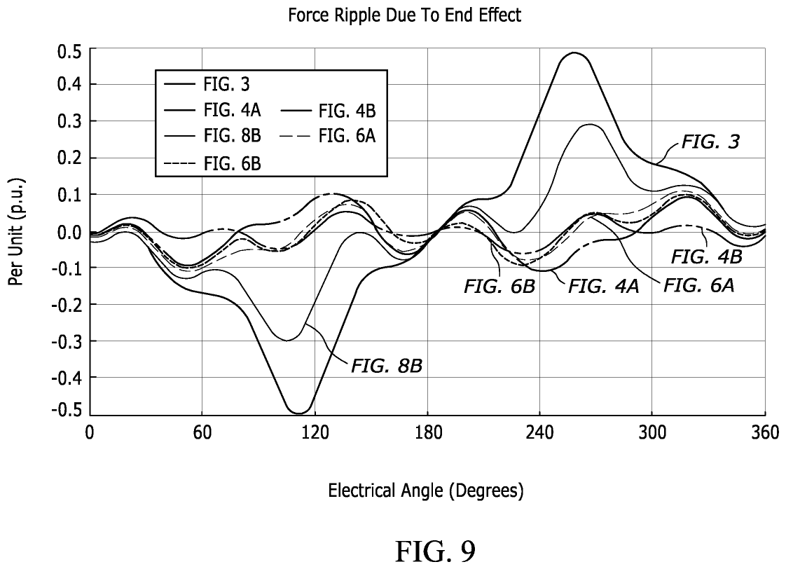

Attention is next directed to FIG. 9 which depicts force ripple (e.g. due an end effect) as a function of electrical angle of the propulsion motors 110 of the examples in FIG. 3, FIG. 4A, FIG. 4B, FIG. 6A, FIG. 6B and FIG. 8B, similar to as in FIG. 2C. As clearly seen from FIG. 9, force ripple is reduced for the propulsion motors 110 of FIG. 4A, FIG. 4B, FIG. 6A, FIG. 6B and FIG. 8B, relative to the propulsion motor 110 of FIG. 3. While examples of reduced force ripple are not depicted for the propulsion motors 110 of the examples in FIG. 5A, FIG. 5B, FIG. 7A, FIG. 7B, FIG. 7C and FIG. 8A, such examples also reduce force ripple. In particular, examples of end ferromagnetic cores 306 shaped to provide one or more of increasing magnetic permeance or decreasing magnetic reluctance from an end 308 of the propulsion motor 110 and/or the movement axis 302 towards a center of the propulsion motor 110 and/or the movement axis 302, may generally reduce 2^{nd} order harmonics in force ripple.

Attention is next directed to FIG. 10A, which depicts a portion of a propulsion motor that includes flat armature coils 1002 around ferromagnetic cores 1004 (e.g. and a cold plate 1006). In contrast, FIG. 10B depicts a portion of the propulsion motor 110 that includes the armature coils 210 around the ferromagnetic cores 206 (e.g. and the cold plate 304); such stepped armature coils 210 are described in detail in Applicant's co-pending application titled “HOMOPOLAR LINEAR SYNCHRONOUS MACHINE” having PCT Patent Application No. PCT/US2019/051701, filed Sep. 18, 2019, and which claims priority from U.S. Patent Application No. 62/733,551, filed Sep. 19, 2018, and the contents of each are incorporated herein by reference.

In particular, the stepped armature coils 210 generally reduce force ripple at the propulsion motor 110 as compared to when the flat armature coils 1002 are used.

In particular, the stepped armature coils 210 are understood to be symmetrically located in slots between the ferromagnetic cores 206, resulting in symmetric phase inductances, that may generally reduce 2^{nd} order harmonics in force ripple. Furthermore, the stepped armature coils 210 are understood to interact with slot leakage flux at both a top and a bottom of slots between the ferromagnetic cores 206, such that the stepped armature coils 210 of all three phases (e.g. presuming the stepped armature coils 210 are controlled according to three different phases) may produce a same amount of Lorentz force (e.g. a Lorentz force of the flat armature coils 1002 may be highest at a top coil (e.g. closest to an opening of a slot) and lowest at a bottom coil (e.g. furthest from an opening of a slot and/or closest to the cold plate 1006). Furthermore, the stepped armature coils 210 are understood to generate less eddy current loss in the cold plate 304 as only about one third of an end winding lies on the cold plate 304 (e.g. the end winding is understood to be a dominant source of cold plate loss).

Hence, it is understood that the propulsion motor 110 may be adapted such that the armature coils 210 comprise stepped armature coils, to further reduce force ripple.

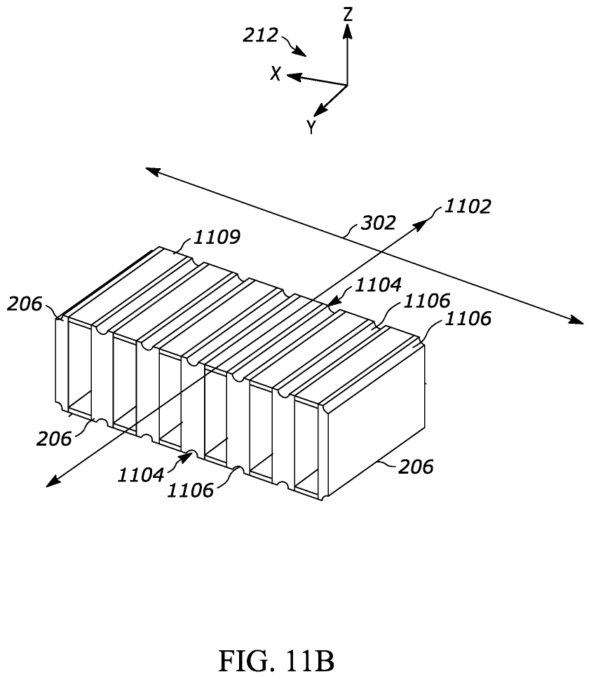

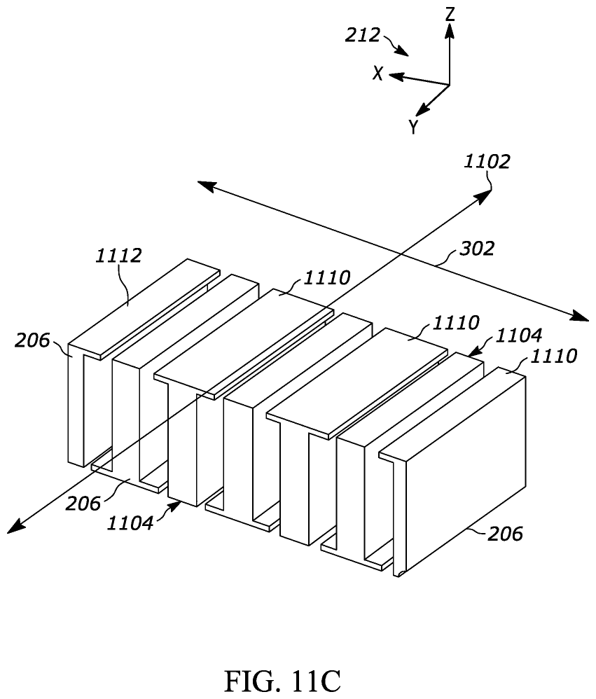

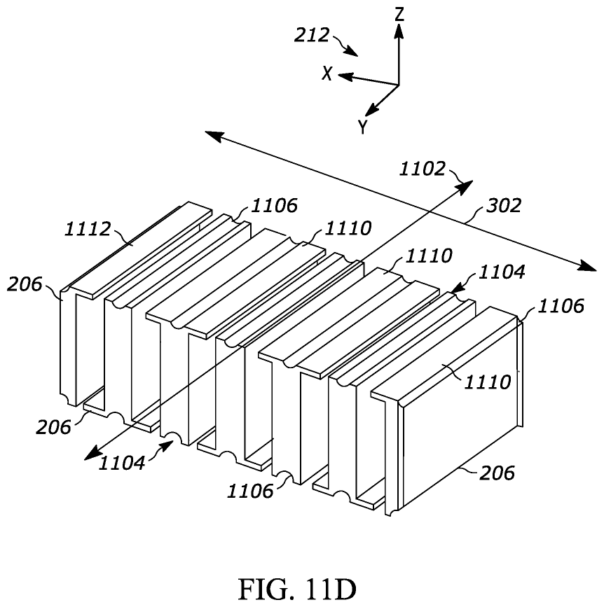

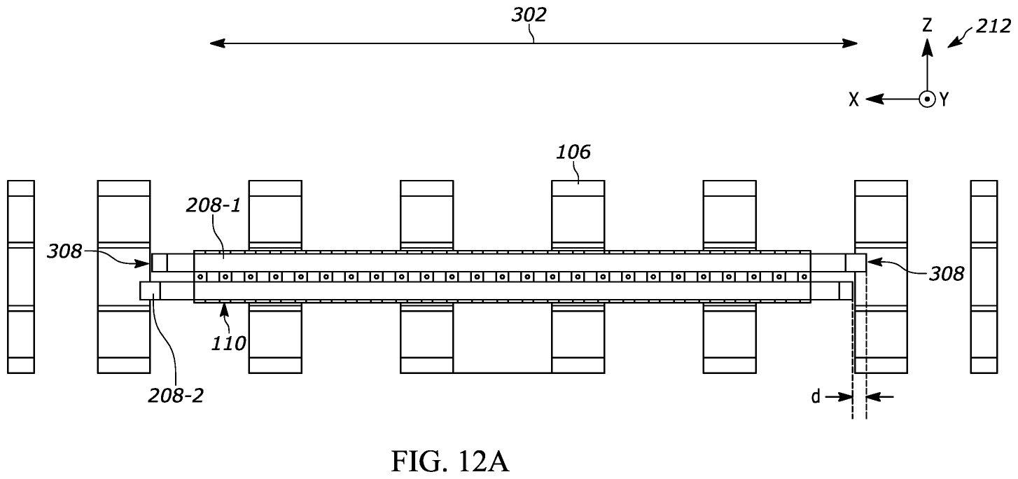

With reference to FIG. 11A, 11B, 11C and 11D, which depicts a portion of the ferromagnetic cores 206 of the propulsion motor 110 according to yet further examples. The ferromagnetic cores 206 may be one or more of: skewed or angled relative to the movement axis 302, forming non-perpendicular angles with the movement axis 302 (e.g. as depicted in FIG. 11A); notched at respective outer ends (e.g. as depicted in FIG. 11B and FIG. 11D); and shaped to include bars that extend along one or more of the respective outer ends (e.g. as depicted in FIG. 11C and FIG. 11D). For clarity, in 11B, 11C and 11D, the ferromagnetic cores 206 are depicted with wireframes showing other components of the propulsion motor 110 (e.g. armature coils, field coils, cold plates, etc. While such wireframes are incomplete in FIG. 11A, other components of the propulsion motor 110 are also assumed to be present in FIG. 11A.

Furthermore, it is understood that, in FIG. 11A, 11B, 11C and 11D that the depicted ferromagnetic cores 206 represent only a portion, for example a center portion, of ferromagnetic cores 206 of different examples of a propulsion motor 110. For example, while the ferromagnetic cores 206 shown at ends of the examples in FIG. 11A, 11B, 11C and 11D appear different from the other ferromagnetic cores 206, such ferromagnetic cores 206 shown at the ends are understood to be truncated, or sectioned, through planes perpendicular to the movement axis 302 and parallel to a lateral axis 1102 perpendicular to the movement axis 302, and that the depicted shapes of the ferromagnetic cores 206 may repeat along the movement axis 302. Hence end ferromagnetic cores 306 are not depicted, but may be similar to any of the examples described herein.

With attention first directed to FIG. 11A, the ferromagnetic cores 206 may be one or more of: skewed or and angled relative to the movement axis 302, forming non-perpendicular angles with the movement axis 302, and/or a lateral axis 1102 perpendicular to the movement axis 302. Such skewing causes the propulsion force that is in the direction of the movement axis 302 to laterally vary in strength along the lateral axis 1102, leading to a reduction in force ripple.

With attention next directed to FIG. 11B, the ferromagnetic cores 206 may be notched at respective outer ends 1104. For example, at the outer ends 1104 (e.g. ends of the ferromagnetic cores 206 that face outward, away from the propulsion motor 110, and/or towards a track segment 106), the ferromagnetic cores 206 may include notches 1106 in a direction of the lateral axis 1102. Such notches 1106 may be arranged along a center of the outer ends 1104 parallel to the lateral axis 1102.

Such notches are understood to reduce force ripple at the propulsion motor 110, for example as the notches decrease magnetic permeance, and/or increase magnetic reluctance, at the location of the notches of the ferromagnetic cores 206, therefore reducing a peak of force ripple.

As also depicted in FIG. 11B, slot wedges 1109 may be located between the ferromagnetic cores 206 at the outer ends 1104. Such slot wedges 1109 may comprise a non-ferromagnetic material and/or ferromagnetic material including, but not limited to, magnetically impregnated fiberglass material, which may assist in reducing force ripple. In particular, the slot wedges 1109 are understood to be less ferromagnetic than the ferromagnetic cores 206 and/or may ferromagnetic as compared to the ferromagnetic cores 206 (e.g. the slot wedges 1109 are 99%, 95%, 90%, less ferromagnetic than the ferromagnetic cores, among other possibilities).

With attention next directed to FIG. 11C, the ferromagnetic cores 206 may be shaped to include bars 1110 that extend along one or more of the respective outer ends 1104 in a direction of the movement axis 302. For example, at the outer ends 1104, the ferromagnetic cores 206 may include the bars 1110, with positions of the bars 1110 on adjacent ferromagnetic cores 206 alternating between opposing outer ends 1104. Such a bar 1110 may be of the same ferromagnetic material as the ferromagnetic cores 206, and may be integrated with a respective ferromagnetic core 206. Such a bar 1110 of a respective ferromagnetic core 206 may extend between (e.g. but not touch) adjacent ferromagnetic cores 206, to about fill a region of slots between the ferromagnetic cores 206.

Such bars 1110 may serve a similar function as the slot wedges 1109, and hence may also assist in reducing force ripple.

In some examples, the features of FIG. 11A, FIG. 11B and FIG. 11C may be combined. For example, the ferromagnetic cores 206 of FIG. 11D may include both the notches 1106 of FIG. 11B and the bars 1110 of FIG. C. While the ferromagnetic cores 206 of the example of FIG. 11D are not skewed as in FIG. 11A, the ferromagnetic cores 206 of the example of FIG. 11D may alternatively be skewed. Similarly, the ferromagnetic cores 206 of the examples of FIG. 11B and/or FIG. 11C may alternatively be skewed.

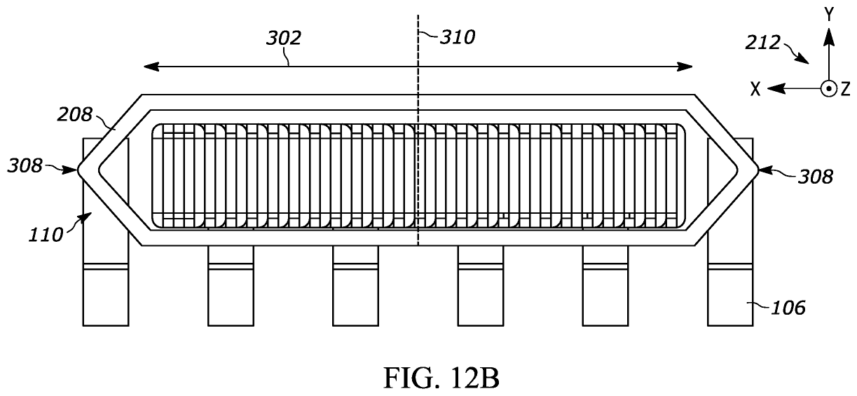

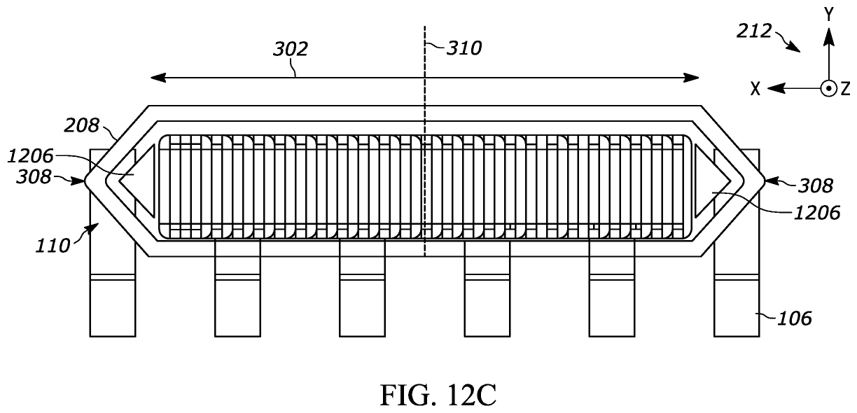

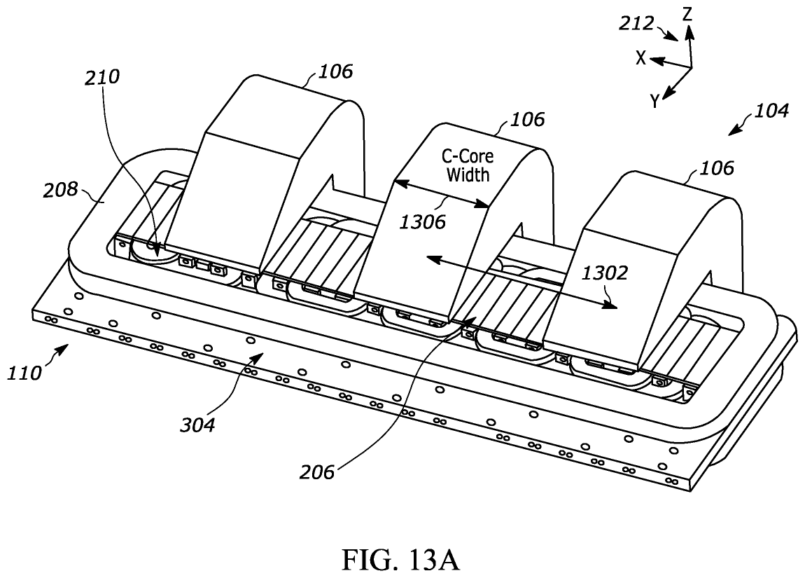

In some examples, the field coils 208 may be adapted to reduce force ripple using offsets along the movement axis 302. For example, attention is next directed to FIG. 12A which depicts a side view the propulsion motor 110 (e.g. moving relative to the track segments 106), adapted to include a first field coil 208-1 and a second field coil 208-2 offset from one another along the movement axis 302. For example, as depicted, the field coils 208 are offset by a distance “d”. As the field coils 208 generally induce a first magnetic flux in the ferromagnetic cores 206 along a magnetic flux pathway formed in combination with the ferromagnetic track segments 106, such an offset may reduce force ripple by distributing the first magnetic flux over a larger area at ends 308 of the propulsion motor 110, as compared to when the field coils 208 are not offset.

In some examples, the offset distance “d” may be less than a width of a track segment 106, along the movement axis 302. longitudinal direction. In other examples, the offset distance “d” may be selected relative to a thickness of a field coil 208; for example, In general, the offset distance “d” may be more than about 25% of the thickness of a field coil 208, and less than about 200% of the thickness of the field coil 208 (e.g. presuming the field coils 208 are a same and/or similar width), among other possibilities.

In some examples, the field coils 208 may be adapted to reduce force ripple by shaping ends of at least one field coils 208. For example, attention is next directed to FIG. 12B which depicts a top view the propulsion motor 110 (e.g. moving relative to the track segments 106, however only a bottom portion of the track segments 106 are depicted for illustrative purposes), adapted to include opposite ends 308 along the movement axis 302 that are narrower relative to a respective center 310 of the at least one field coil 208. For example, as depicted, the depicted field coil 208 has a triangular shape at the ends 308, with a tip of a respective triangle being towards a respective end 308, and a “base” of a respective triangle being towards the center 310. Such a shape, (and/or any suitable shape in which the field coil 208 widens from a respective ends 308 along the movement axis 302 towards the center 310) may reduce force ripple by more gradually inducing the first magnetic flux at the track segments 106 at the ends 308, as compared to when an end of a field coil 208 has a more blunt and/or rectangular shape (e.g. as depicted in FIG. 2A).

In some examples, the propulsion motor 110, as depicted in FIG. 12C may be adapted to include ferromagnetic devices 1206 located at respective ends 308, and inside the field coil 208 of the example of FIG. 12B. The ferromagnetic devices 1206 may be similar the ferromagnetic cores 206, and may comprise a same or different ferromagnetic material as the ferromagnetic cores 206, but the armature coils 210 are not around the ferromagnetic devices 1206. The ferromagnetic devices 1206 are shaped to provide one or more of increasing magnetic permeance or decreasing magnetic reluctance from a respective end 308 of the propulsion motor 110 and/or the movement axis 302, towards the center of the propulsion motor 110 and/or the movement axis 302. Hence, as depicted, the ferromagnetic devices 1206 are triangular and/or wedge shaped (e.g. and/or flatiron shaped), with a tip of a respective triangle/edge a ferromagnetic device 1206 being towards a respective end 308, and a base of a respective triangle/edge a ferromagnetic device 1206 being towards the center 310. In some examples, shapes of the ferromagnetic devices 1206 may be complementary to a shape of the field coil 208 (e.g. both have triangular shapes, with the ferromagnetic devices 1206 fitting inside tips of respective ends 308 of the field coil 208).

The ferromagnetic devices 1206 may reduce force ripple in a manner similar to the end ferromagnetic device 306.

In some examples, the track 104 and/or the track segments 106 may be adapted to reduce force ripple.

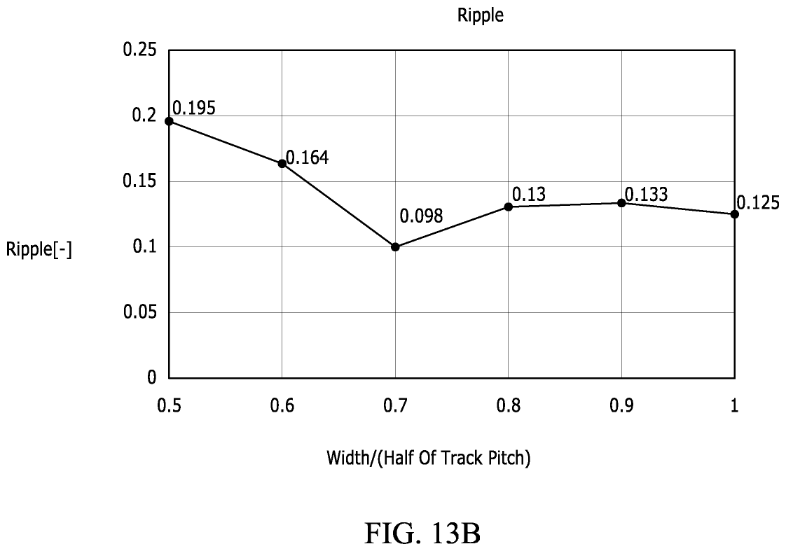

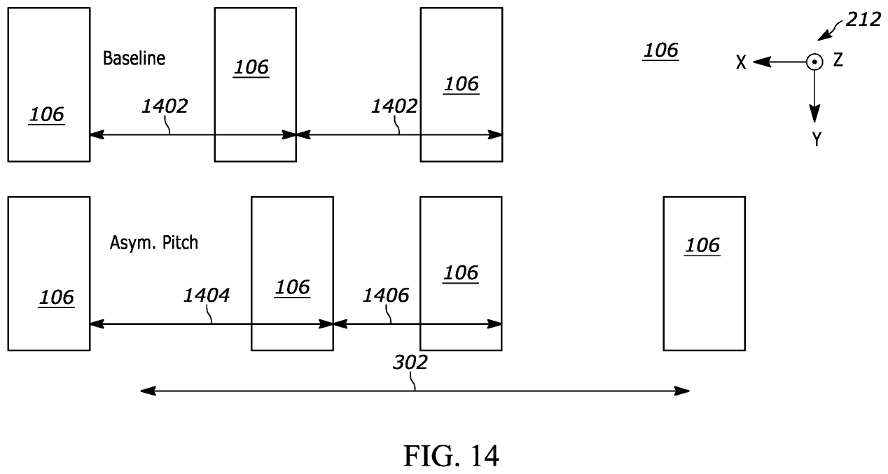

For example, attention is next directed to FIG. 13A which depict a perspective view of portion of the track 104 and the track segments 106, and yet another example of the propulsion motor 110. In particular, the track 104 comprises the plurality of track segments 106 relative to which the propulsion motor 110 is propelled by the plurality of track segments 106 (e.g. acting as a rotor component of a magnetic machine and the propulsion motor 110 acting as a stator component of the magnetic machine), the plurality of track segments 106 and the propulsion motor 110, together forming a homopolar linear synchronous machine, such as homopolar linear synchronous machine 200.

As depicted, a distance between centers of adjacent track segments 106, along the track 104, defines a pitch of adjacent track segments 106. Hereafter this distance will be referred to as a track pitch 1302. A distance of a track segment 106 along the track 104 is understood to comprise a width 1306 of a track segment 106. By selecting certain ratios of a width 1306 of a track segment 106 along the track 104, to the track pitch 1302, force ripple may be reduced. In particular, a ratio of the width 1306 of the track segment 106 along the track 104, to the half of track pitch 1302 may be selected to be about 0.7 to most effectively reduce force ripple.

For example, attention is directed to FIG. 13B which depicts force ripple as a function of width 1306 of a track segment 106, to the half of track pitch 1302; at a ratio of 0.7, the force ripple is understood to be minimized relative to other ratios between 0.5 and 1.

In some examples, the track 104 may be adapted to reduce force ripple in other configurations.

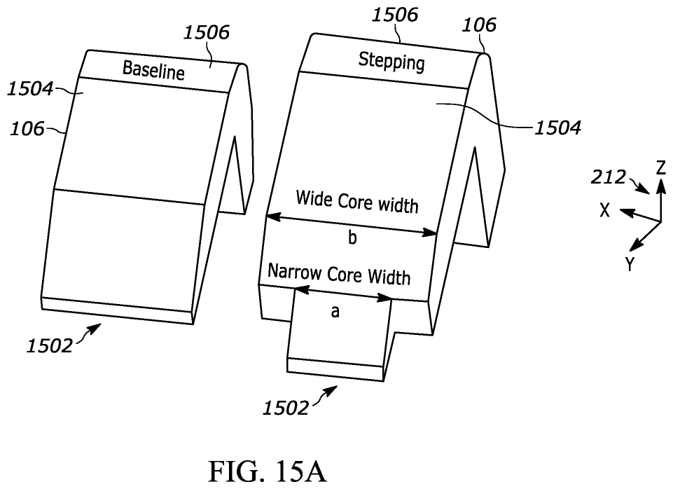

For example, attention is next directed to FIG. 14 which depicts a schematic view of two sets of track segments 106. In a “baseline” configuration, a pitch 1402 of adjacent track segments 106 (e.g. a distance between adjacent track segments 106) are the same. Presuming a width of the track segments 106 are the same, the pitch 1402 being the same leads to a track pitch being the same between the track segments 106.

In comparison, in an “asymmetric” configuration, a pitch of the plurality of track segments 106 along the movement axis 302 of the propulsion motor 110 one or more of varies, and alternates between a larger pitch 1404 and a smaller pitch 1406. Indeed, by selecting a suitable difference between the larger pitch 1404 and the smaller pitch 1406, which may be determined heuristically, force ripple of may be reduced as much as 85%.

Indeed, adjusting a pitch of the track segments 106 may be implemented in tandem with selecting a ratio of the width 1306 of the track segment 106 along the track 104, to the track pitch 1302, and/or such examples may be performed independent of each other.

In some examples, the track 104 may be adapted to reduce force ripple in yet other configurations.

For example, the plurality of track segments 106 may comprise one or more of steps, rounded corners, and notches, and the like, to one or more of at least partially increase magnetic permeance or at least partially decrease magnetic reluctance from about a propulsion motor-facing end to an opposite end, perpendicular to a movement axis of the propulsion motor. Such steps, rounded corners, and notches, and the like, may be provided in addition to any chamfers at the track segments 106.

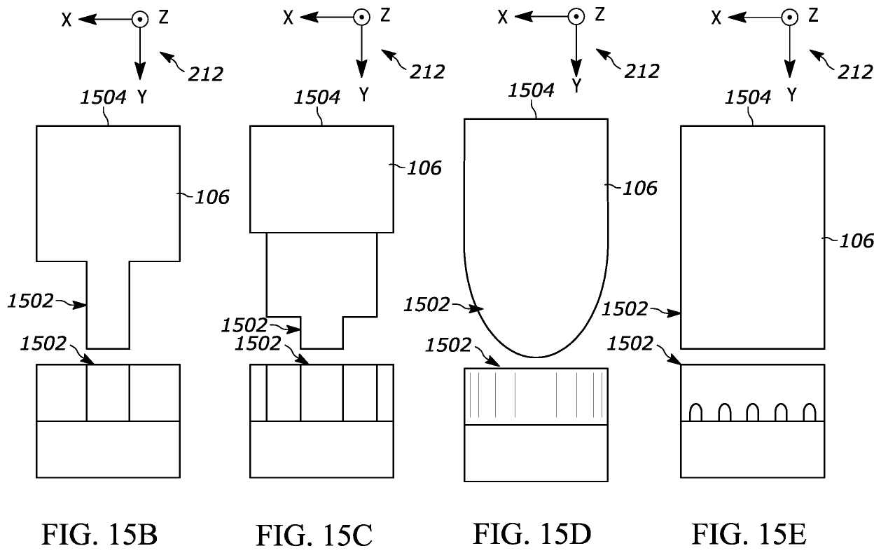

For example, attention is next directed to FIG. 15A which depicts a “baseline” configuration of a portion of an example track segment 106 that may be similar in shape to the track segments 106 of the example of FIG. 2, or any other suitable shape. In particular, the track segment 106 of the baseline configuration includes a propulsion motor-facing end 1502 and an opposite end 1504 (e.g. that may be integral with a back 1506 of the track segment 106).

However, in a depicted “stepping” configuration, an example track segment 106 includes a step at the propulsion motor-facing end 1502, having a width “a”, which is narrower than a remainder of the example track segment 106 which has a width “b”. Hence, the step further causes the track segment 106 of the “stepping” configuration to at least partially increase in magnetic permeance and/or or at least partially decrease in magnetic reluctance from the propulsion motor-facing end 1502 to the opposite end 1504

Another “stepping” configuration of another example track segment 106 is depicted in a plan view and a front elevation view (e.g. from the propulsion motor-facing end 1502) in FIG. 15B, with the plan view being in the top portion of FIG. 15B, and the front elevation view being in the bottom portion of FIG. 15B. Hence, FIG. 15B further shows a step that is longer than the step of the “stepping” configuration of FIG. 15A.

Attention is next directed to FIG. 15C which depicts another “stepping” configuration of another example track segment 106 in a plan view and a front elevation view (e.g. from the propulsion motor-facing end 1502) in FIG. 15C, with the plan view being in the top portion of FIG. 15B, and the front elevation view being in the bottom portion of FIG. 15C. In the example of FIG. 15C, the example track segment 106 includes a plurality of steps which successively widen from the propulsion motor-facing end 1502 towards the opposite end 1504.

Attention is next directed to FIG. 15D which depicts a rounded configuration of another example track segment 106 in a plan view and a front elevation view (e.g. from the propulsion motor-facing end 1502) in FIG. 15D, with the plan view being in the top portion of FIG. 15B, and the front elevation view being in the bottom portion of FIG. 15D. In the example of FIG. 15D, the propulsion motor-facing end 1502 of the example track segment 106 is rounded such that that the example track segment 106 widens in a rounded fashion from a tip at the propulsion motor-facing end 1502 towards the opposite end 1504.

Attention is next directed to FIG. 15E which depicts a notched configuration of another example track segment 106 in a plan view and a front elevation view (e.g. from the propulsion motor-facing end 1502) in FIG. 15E, with the plan view being in the top portion of FIG. 15B, and the front elevation view being in the bottom portion of FIG. 15E. In the example of FIG. 15E, the propulsion motor-facing end 1502 of the example track segment 106 includes notches partway through the example track segment 106 from the propulsion motor-facing end 1502 towards the opposite end 1504.

The vehicle 112 may also be adapted to reduce force ripple.

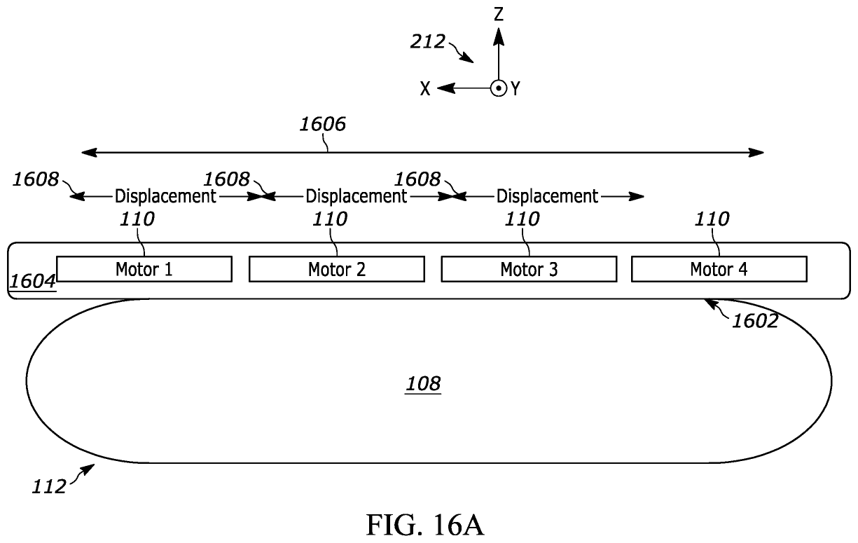

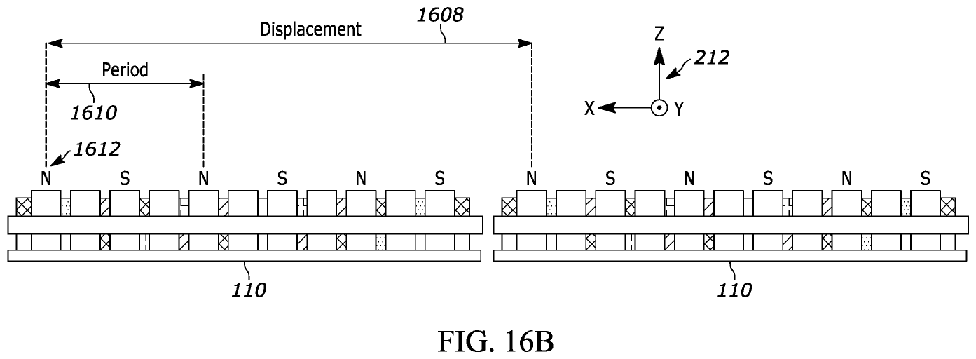

For example, attention is next directed to FIG. 16A which depicts an example of the vehicle 112 that includes a body 1602 (e.g. the payload 108 and a structure 1604 (colloquially referred to as a bogie) attached to the payload 108), to which a plurality of propulsion motors 110 are attached at a side of the body 1602, for example arranged in a line about parallel to a movement axis 1606 of the body 1602 (e.g. the movement axis 1606 may be parallel to respective movement axes 302 of the propulsion motors 110).

As depicted, the propulsion motors 110 are displaced from one another by respective displacements 1608 along a movement axis 1606 of the vehicle 112. A displacement 1608 is understood to comprise a distance between similar reference points of adjacent propulsion motors 110. For example, assuming the propulsion motors 110 all have a similar and/or same configuration, a displacement 1608 between adjacent first and second propulsion motors 110 may comprise a distance between a center of a left most ferromagnetic core of the first propulsion motor 110 and respective center of a left most respective ferromagnetic core of the second propulsion motor 110, however such displacements 1608 may be defined based on any suitable reference points. Indeed, the displacements 1608 are generally independent of such reference points, as long as a same reference point is used for each pair of adjacent propulsion motors 110.

In general, to reduce force ripple when interacting with a propulsion track (e.g. the track 104 comprising the track segments 106), the displacements 1608 between adjacent propulsion motors 110 may be selected according to an electrical period 1610 along the movement axis 1606, described below with respect to FIG. 16B. Furthermore, it is understood that the electrical period 1610 generally depends on the track pitch (e.g. a distance between the track segments 106), and/or displacement of the armature coils 208 (e.g. as described in Applicant's co-pending application titled “HOMOPOLAR LINEAR SYNCHRONOUS MACHINE” having PCT Patent Application No. PCT/US2019/051701, filed Sep. 18, 2019, and which claims priority from U.S. Patent Application No. 62/733,551, filed Sep. 19, 2018, and the contents of each are incorporated herein by reference).

In particular, the displacements 1608 may be selected based on: an electrical period 1610 of poles of the plurality of propulsion motors 110; and an offset distance determined from the electrical period, a number of the plurality of propulsion motors 110; and a given integer value. In particular, as will be explained hereafter, the offset distance is determined by dividing the electrical period into the offset distance to determine a remainder, for example using a modulo function, described in more detail below. The electrical period divided by the remainder is about equal to a number of the plurality of propulsion motors divided by a given integer value that is less than the number of the plurality of propulsion motors, and produces a largest common divider between the given integer value and the number of the plurality of propulsion motors of 1.

The displacements 1608 may be the same, or different from one another.

For example, attention is directed to FIG. 16B which depicts an examples of adjacent propulsion motors 110 of the vehicle 112 of FIG. 16B, showing displacement 1608 therebetween (e.g. between centers of leftmost ferromagnetic cores), and an electrical period 1610 of one of the propulsion motors 110. For example, the electrical period 1610 may be defined as a distance between two closest magnetic north poles 1612, or two closest magnetic south poles 1612 (e.g. which are generally a same distance). It is assumed, in these examples, that the electrical period 1610 of all the propulsion motors 110 are the same.

Furthermore, it is assumed that the electrical period 1610 is a known and/or predetermined value, and that an offset distance for the displacements 1608 may be determined from the following equations:

$$Electrical Period = Mod ( Offset , Electrical Period ) \times \frac{n}{k} \qquad Equation ( 1 )$$

In Equation (1) “Mod” is the modulo function, which returns a remainder of a division, after one number (e.g. which may be referred to as the dividend and, in as shown in Equation (1) the “Offset” is the dividend) is divided by another (e.g. which may be referred to as the divisor and, in as shown in Equation (1) the “Electrical Period” is the divisor).

Furthermore, in Equation (1), “Electrical Period” is understood to be the electrical period 1610, “Offset” is an offset distance, “n” is the number of propulsion motors 110 (e.g. “4” in FIG. 16A), and k is a given integer value which comprises an integer which is less than the number of the plurality of propulsion motors “n”, and produces a largest common divider between the given integer value “k” and the number “n” of the plurality of propulsion motors of “1”.

For example, if “n” is “4” than “k” may be selected to be “1” or “3” as a largest common divider between “4” and “1” is “1”, and a largest common divider between “4” and “3” is also “1”. In contrast, “k” cannot be “2” as a largest common divider between “4” and “2” is “2”, and not “1”. Continuing with the example of “n” being “4”, whether or not a value of “k” of “1” or “3” is selected may depend on physical constraints and/or requirements of the vehicle 112 and/or the propulsion motors 110. For example, values of “k” of “1” or “3” will produce different offset values, one of which may produce displacements 1608 which are more suited to a length of the vehicle 112 and/or the propulsion motors 110 than another. In practise, displacements 1608 determined using offsets for values of “k” of “1” or “3” may be generated (described below) and heuristically evaluated using given physical constraints and/or requirements of the vehicle 112 and/or the propulsion motors 110 (e.g. such as length)

Hence, put another way, an offset distance may be determined from a modulo function of the offset distance (the dividend) and the electrical period (e.g. the divisor), the modulo function multiplied by the number of the plurality of propulsion motors and divided by the given integer value k, and set equal to the electrical period.

When the offset distance is less than the electrical period, the function Mod (Offset, Electrical Period) of Equation (1) may generally yield the offset distance as the remainder. Put another way, when the offset distance is less than the electrical period, the remainder comprises the offset distance. In contrast, when the offset distance is greater than the electrical period, the remainder the comprises: an integer multiple of the electrical period subtracted from the offset distance, for example where the integer multiple is greater than zero (“0”); however, in these examples, it is understand that the integer multiple of the electrical period, that is subtracted from the offset distance, is less than the offset distance (e.g. understood as being a general manner in which the modulo function behaves).

However, it is understood that when the offset distance is less than the electrical period, the remainder may also comprise: an integer multiple of the electrical period subtracted from the offset distance, but where the integer multiple is zero (“0”).

Regardless, in these examples, rearranging Equation (1) the electrical period divided by the remainder (e.g. that occurs from MOD (Offset, Electrical Period)) is about equal to a number “n” of the plurality of propulsion motors divided by the given integer value “k” (e.g. that is less than the number of the plurality of propulsion motors, and produces a largest common divider between the given integer value and the number of the plurality of propulsion motors of 1).

Furthermore, in some examples, the offset distance may be adjusted to be within (e.g. plus or minus) about one or more of 15%, 10% and 5% of an initial calculation of the offset distance Equation (1).

Once Equation (1) is solved for the offset distance, the displacements 1608 may be determined from:

$$Displacement = Electrical period \times i \pm Offset \qquad Equation ( 2 )$$

In Equation (2), “Displacement” is a displacement 1608, “Electrical Period” is the electrical period 1610, “Offset” is the offset distance determined from Equation (1), and “i” is an integer value selected such that an integer multiple “i” of the electrical period 1610 is greater than a length of a propulsion motor 110. Furthermore, in Equation (2), a displacement 1608 is determined from an integer multiple (e.g. “i”) of the electrical period 1610 of poles of the plurality of propulsion motors 110, adjusted by adding or subtracting the offset distance.

Hence, for example, once the offset distance is determined from Equation (1), Equation (2) may be used to determine one or more displacements 1608, for example by adding and/or subtracting the offset distance to integer multiples of the electrical period 1610. In a particular example: a displacement 1608 between the adjacent propulsion motors 110 of the vehicle 112, may be determined by adding, or subtracting, the offset distance to integer multiples of the electrical period 1610, and which may be the same for all adjacent propulsion motors 110, as long as a determined displacement 1608 is longer than a propulsion motor 110.

For example, once an offset is determined, different integers “i” may be used to determine different displacements 1608, and once a displacement 1608 is determined that is longer than a propulsion motor 110, that displacement 1608 may be used for adjacent propulsion motors 110. In some examples, a smallest displacement 1608 may be used that is longer than a propulsion motor 110, however, in other examples, any suitable displacement 1608 may be used, for example to space the propulsion motors 1608 along the vehicle 112 in any suitable manner. For example, it may be preferable to have propulsion motors 1608 that are as close to opposite ends of the vehicle 112 as possible (e.g. along the movement axis 1606) and as there is a given number “n” of propulsion motors 110, a value of the integer “k” in Equation (1), and a value of the integer “i” in Equation (2), may be selected that results in a displacement 1608 that spaces and/or locates the propulsion motors 110 along the vehicle 112 accordingly.

In some examples, a displacement 1608 between adjacent propulsion motors 110 may be the same, or the displacements 1608 may vary and/or be different, for example by using different values of the integer “k” in Equation (1), and/or different values of the integer “i” in Equation (2) and/or by adding and subtracting determined offset values in Equation (2). Such varying of displacements 1608 may occur to meet given physical constraints of the vehicle 112 and/or the propulsion motors 110, and the like. Hence, in general, to reduce force ripple, adjacent displacements 1608 are selected to be different or the same from each other.

Hence, the value of “i” used for determining the integer multiples of the electrical period 1610 in Equation (2) may be the same or different when determining the displacements 1608. However, in some examples, the integer “i” may be selected for the integer multiple of the electrical period 1610 that results in a distance that minimizes the displacements 1608 between the plurality of propulsion motors 110, for example to reduce the overall total combined length of the propulsion motors 110. Similar constraints may be placed on the integer “k” in Equation (1) (e.g. an integer “k” may be selected that results in a distance that minimizes the displacements 1608 between the plurality of propulsion motors 110, for example to reduce the overall total combined length of the propulsion motors 110).

It is furthermore understood that a method may be used to determine the displacements, the method comprising: for plurality of propulsion motors at a side of a body of a vehicle, the plurality of propulsion motors arranged in a line about parallel to a movement axis of the body, determining displacements between adjacent propulsion motors along the movement axis according to an electrical period of poles of the plurality of propulsion motors, and an offset distance, wherein the offset distance is determined by dividing the electrical period into the offset distance to determine a remainder, and wherein the electrical period divided by the remainder is about equal to a number of the plurality of propulsion motors divided by a given integer value that is less than the number of the plurality of propulsion motors, and produces a largest common divider between the given integer value and the number of the plurality of propulsion motors of 1.

At such a method, when the offset distance is greater than the electrical period, the remainder may comprise: an integer multiple of the electrical period distance subtracted from the offset distance.

At such a method, when the offset distance is less than the electrical period, the remainder may comprise the offset distance.

At such a method, the remainder may be determined from a modulo function of the offset distance and the electrical period, the modulo function multiplied by the number of the plurality of propulsion motors and divided by the given integer value, and set equal to the electrical period.

At such a method, the displacements may be determined from an integer multiple of the electrical, adjusted by adding or subtracting an offset distance. An integer selected for the integer multiple of the electrical period may result in a distance that minimizes the displacements between the plurality of propulsion motors.

At such a method, the offset distance as determined may be adjusted to be within about one or more of 15%, 10% and 5% of an initial calculation of the offset distance (e.g. using Equation (1).

At such a method, the displacements between the adjacent propulsion motors may be about the same for all of the adjacent propulsion motors.

At such a method, the displacements between the adjacent propulsion motors may vary for at least a portion of the adjacent propulsion motors

It is furthermore understood that the propulsion motors 110 of the vehicle 112 of the example of FIG. 16A, and/or a track 104 and/or track segments 106 therefor, may be adapted according to any of the other examples provided herein in FIG. 4A to FIG. 15B.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that there are yet more alternative examples and modifications possible, and that the above examples are only illustrations of one or more examples. The scope, therefore, is only to be limited by the claims appended hereto.

What is claimed is:

1. A vehicle comprising:
a body; and
a plurality of propulsion motors at a side of the body, arranged in a line about parallel to a movement axis of the body, wherein displacements between adjacent propulsion motors along the movement axis are selected according to an electrical period of poles of the plurality of propulsion motors, and an offset distance,
wherein the offset distance is determined by dividing the electrical period into the offset distance to determine a remainder,
and wherein the electrical period divided by the remainder is about equal to a number of the plurality of propulsion motors divided by a given integer value that is less than the number of the plurality of propulsion motors, and produces a largest common divider between the given integer value and the number of the plurality of propulsion motors of 1.

2. The vehicle of claim 1, wherein, when the offset distance is greater than the electrical period, the remainder the comprises: an integer multiple of the electrical period distance subtracted from the offset distance.

3. The vehicle of claim 1, wherein, when the offset distance is less than the electrical period, the remainder comprises the offset distance.

4. The vehicle of claim 1, wherein the remainder is determined from a modulo function of the offset distance and the electrical period, the modulo function multiplied by the number of the plurality of propulsion motors and divided by the given integer value, and set equal to the electrical period.

5. The vehicle of claim 1, wherein the displacements are determined from an integer multiple of the electrical, adjusted by adding or subtracting an offset distance.

6. The vehicle of claim 5, wherein an integer selected for the integer multiple of the electrical period results in a distance that minimizes the displacements between the plurality of propulsion motors.

7. The vehicle of claim 1, wherein the displacements are greater than a length of a propulsion motor.

8. The vehicle of claim 1, wherein the offset distance as determined is adjusted to be within about one or more of 15%, 10% and 5% of an initial calculation of the offset distance.

9. The vehicle of claim 1, wherein the displacements between the adjacent propulsion motors are about the same for all of the adjacent propulsion motors.

10. The vehicle of claim 1, wherein the displacements between the adjacent propulsion motors vary for at least a portion of the adjacent propulsion motors.

11. A method comprising:
for plurality of propulsion motors at a side of a body of a vehicle, the plurality of propulsion motors arranged in a line about parallel to a movement axis of the body,
determining displacements between adjacent propulsion motors along the movement axis according to an electrical period of poles of the plurality of propulsion motors, and an offset distance,
wherein the offset distance is determined by dividing the electrical period into the offset distance to determine a remainder,
and wherein the electrical period divided by the remainder is about equal to a number of the plurality of propulsion motors divided by a given integer value that is less than the number of the plurality of propulsion motors, and produces a largest common divider between the given integer value and the number of the plurality of propulsion motors of 1.

12. The method of claim 11, wherein, when the offset distance is greater than the electrical period, the remainder the comprises: an integer multiple of the electrical period distance subtracted from the offset distance.

13. The method of claim 11, wherein, when the offset distance is less than the electrical period, the remainder comprises the offset distance.

14. The method of claim 11, wherein the remainder is determined from a modulo function of the offset distance and the electrical period, the modulo function multiplied by the number of the plurality of propulsion motors and divided by the given integer value, and set equal to the electrical period.

15. The method of claim 11, wherein the displacements are determined from an integer multiple of the electrical, adjusted by adding or subtracting an offset distance.

16. The method of claim 15, wherein an integer selected for the integer multiple of the electrical period results in a distance that minimizes the displacements between the plurality of propulsion motors.

17. The method of claim 11, wherein the displacements are greater than a length of a propulsion motor.

18. The method of claim 11, wherein the offset distance as determined is adjusted to be within about one or more of 15%, 10% and 5% of an initial calculation of the offset distance.

19. The method of claim 11, wherein the displacements between the adjacent propulsion motors are about the same for all of the adjacent propulsion motors.

20. The method of claim 11, wherein the displacements between the adjacent propulsion motors vary for at least a portion of the adjacent propulsion motors.
